(19) United States
(12) Patent Application Publication
(10) Pub. No.: US 2019/0392677 A1
(43) Pub. Date: Dec. 26, 2019

(54) GAMING SYSTEM AND METHOD INCLUDING REPLICATING SYMBOLS

(71) Applicant: ADP GAUSELMANN GMBH, Espelkamp (DE)

(72) Inventor: Michael Charles Halvorson, Las Vegas, NV (US)

(21) Appl. No.: 16/549,948

(22) Filed: Aug. 23, 2019

Related U.S. Application Data
(63) Continuation-in-part of application No. 16/019,511, filed on Jun. 26, 2018.

(51) Int. Cl. G07F 17/32; G07F 17/34

(52) U.S. Cl. CPC G07F 17/3213; G07F 17/34; G07F 17/3244

(57) ABSTRACT

Various implementations of a gaming system and method offer replicating symbols. For example, gaming system generates a plurality of symbols for a play of a game, wherein at least one of the plurality of symbols can be a replicating symbol. Replicating symbols can be used to enhance a game outcome or award for player during a play of the game. The gaming system can determine a path of motion for a generated replicating symbol. The path can be predetermined or dynamically generated for the generated replicating symbols. The gaming system may randomly generate stop positions along the path. The gaming system may deposit copies of the generated replicating symbol at the generated stop positions. The gaming system evaluates the plurality of symbols and any displayed replicating symbols for winning symbol combinations and for determining any awards based on the evaluated winning symbol combinations.

### CROSS-REFERENCE TO RELATED APPLICATION

The present application claims priority under 35 U.S.C. § 120 as a Continuation-in-Part of prior U.S. patent application Ser. No. 16/019,511, filed Jun. 26, 2018, the content of which is incorporated herein in its entirety.

### FIELD

The present disclosure relates to gaming systems.

### BACKGROUND

Gaming machines that accept wagers in exchange for the opportunity to win awards or prizes are known. Gaming machines that offer new ways to win awards or prizes are needed to gain and retain players' interest in the gaming machines.

### SUMMARY

The present disclosure is directed to systems and processes for gaming. A gaming system consistent with some implementations disclosed herein provides a game that randomly determines symbols and displays such symbols to players using a game display device. The gaming system evaluates the displayed symbols to determine whether they correspond to predetermined awards.

Various implementations of a gaming system and method generate a plurality of symbols for a play of a game, wherein at least one of the plurality of symbols can be a replicating symbol. Replicating symbols can be used to enhance a game outcome or award for player during a play of the game. The gaming system can determine a path of motion for a generated replicating symbol. The path can be predetermined or dynamically generated for the generated replicating symbols. The gaming system may randomly generate stop positions for the replicating symbol along the path. The gaming system may deposit copies of the generated replicating symbol at the generated stop positions. The gaming system evaluates the plurality of symbols and any displayed replicating symbols for winning symbol combinations and for determining any awards based on the evaluated winning symbol combinations.

By providing replicating symbols, the gaming system provides new ways to enhance game outcomes and improved player awards, which reduces potential player disappointment with game outcomes and enhances player excitement for the game. The new potential to improve or earn greater awards creates a greatly improved sense of anticipation and game for players.

As described above and set forth in greater detail below, gaming systems in accordance with aspects of the present disclosure provide a specialized computing device integrating non-generic hardware and software that improve upon the existing technology of human-computer interfaces by providing unconventional functions, operations, and symbol sets for generating interactive displays and outputs. The features of the gaming system provide a practical implementation that improves the operation of the gaming systems for their specialized purpose of providing entertainment by reducing player disappointment with game outcomes, by enhancing player enjoyment, and by increasing player engagement.

In some implementations, the features described herein technically improve the operation of gaming systems for their specialized purpose by merging multiple game aspects (e.g., game features, game stages, or sub-games) into a single game presented on a common game display device so that the overlapping game aspects operate in cooperation, rather than operating in isolation. For example, gaming systems in accordance with the present disclosure can provide a bonus game and expansion feature using the same symbol display areas as those used for a base game. Merging the multiple game aspects so they overlap and cooperate in a common game display device technically improves some implementations of the gaming system by reducing the display area used by the gaming system. Thereby, such implementations of the gaming system can reduce power consumption in comparison to gaming systems that use, for example, a display area to display a base game, and a different display area to display a substantially separate bonus game. Further, doing so can reduce the physical complexity and manufacturing cost of the gaming systems in some implementations by reducing the number or size of game display devices included in the gaming systems.

Additionally, the features of the gaming system technically improve the operation of the gaming systems for their specialized purpose by providing unique combinations of functions that link game aspects having multiple rounds. Linking two or more game aspects together allows games initiated by gaming systems in accordance with the present disclosure can be completed more quickly than systems that provide such games separately. By doing so, the disclosed gaming systems can increase the usage rate (e.g., duty cycle) of the gaming system by allowing more games to be completed in a shorter time period (e.g., games per hour or games per minute) and by reducing power consumed during a single play of the game. When such speed and efficiency improvements are applied in the hundreds or thousands of game evaluations performed over time at multiple installations of the gaming system (e.g., multiple devices installed at multiple casinos), some implementations of the disclosed gaming system provide gaming operators substantial improvement in gaming system efficiency.

### BRIEF DESCRIPTION OF THE DRAWINGS

FIG. 1 is a perspective view of one implementation of a stand-alone gaming system of a gaming system in accordance with aspects of the present disclosure.

FIG. 2 is a functional block diagram of the gaming system technology components of the gaming system in accordance with aspects of the present disclosure.

FIGS. 3A, 3B, 3C, and 3D illustrate one implementation of a method of operating the gaming system having replicating symbols for enhancing awards in accordance with aspects of the present disclosure.

FIGS. 4A, 4B, 4C, 4D, and 4E illustrate screen shots of one implementation of a gaming system having replicating symbols for enhancing awards in accordance with aspects of the present disclosure.

FIG. 5 illustrates one implementation of a pay table in a gaming system having replicating symbols for enhancing awards in accordance with aspects of the present disclosure.

FIG. 6 illustrates a screen shot of another implementation of a gaming system having replicating symbols for enhancing awards in accordance with aspects of the present disclosure.

FIG. 7 illustrates one implementation of a plurality of gaming systems that are networked together and have replicating symbols for enhancing awards in accordance with aspects of the present disclosure.

FIGS. 8A, 8B, 8C, and 8D illustrate a method of operating the gaming system having replicating symbols for enhancing awards in accordance with aspects of the present disclosure.

FIGS. 9A, 9B, 9C, and 9D illustrate screen shots of an implementation of a gaming system in accordance with aspects of the present disclosure.

FIG. 10 illustrates a screen shot of an implementation of a gaming system in accordance with aspects of the present disclosure.

FIGS. 11A, 11B, and 11C illustrate screen shots of an implementation of a gaming system in accordance with aspects of the present disclosure.

FIG. 12 illustrates a screen shot of an implementation of a gaming system in accordance with aspects of the present disclosure.

### DETAILED DESCRIPTION

Various implementations of a gaming system and method generates a plurality of symbols for a play of a game, wherein at least one of the plurality of symbols can be a replicating symbol. Replicating symbols can be used to enhance a game outcome or award for player during a play of the game. The gaming system can determine a path of motion for a generated replicating symbol. The path can be predetermined or dynamically generated for the generated replicating symbols. The gaming system may randomly generate stop positions for the replicating symbol along the path. The gaming system may deposit copies of the generated replicating symbol at the generated stop positions. The gaming system evaluates the plurality of symbols and any displayed replicating symbols for winning symbol combinations and for determining any awards based on the evaluated winning symbol combinations.

Various implementations in accordance with the present disclose provide systems, methods, and computer-program products for a gaming system. A gaming consistent with aspects the present disclosure includes a display device, an input device, a value acceptor, a value dispenser, a random number generator, a memory device, and a processor. The memory device stores program instructions that, when executed by the processor, cause the gaming system to perform operations including receiving a wager for a game using a credit balance established for the gaming system. The operations also include randomly determining symbols for symbol display areas. The operations also include displaying the symbols in the symbol display areas. The operations also include determining that a replicating symbol is displayed in response to an occurrence of a predetermined event. The operations also include moving the replicating symbol through the symbol display areas. The operations also include randomly determining one or more of the symbol display areas as stop positions for the replicating symbol. The operations also include displaying one or more copies of the replicating symbol based on the stop positions for the replicating symbol. The operations also include determining an award based on the symbols and the one or more copies of the replicating symbol. The operations also include updating the credit balance based on the award. The operations also include issuing the credit balance in response to a cash out request.

### Gaming System Platform

The features and advantages of the gaming system and method described herein may be provided to a player via a gaming system platform that includes various structures and components for allowing player interaction with the gaming system. While only one gaming system platform will be described in detail herein, the features, objects, and advantages of the gaming system described herein may be implemented in one or more alternative gaming system platforms.

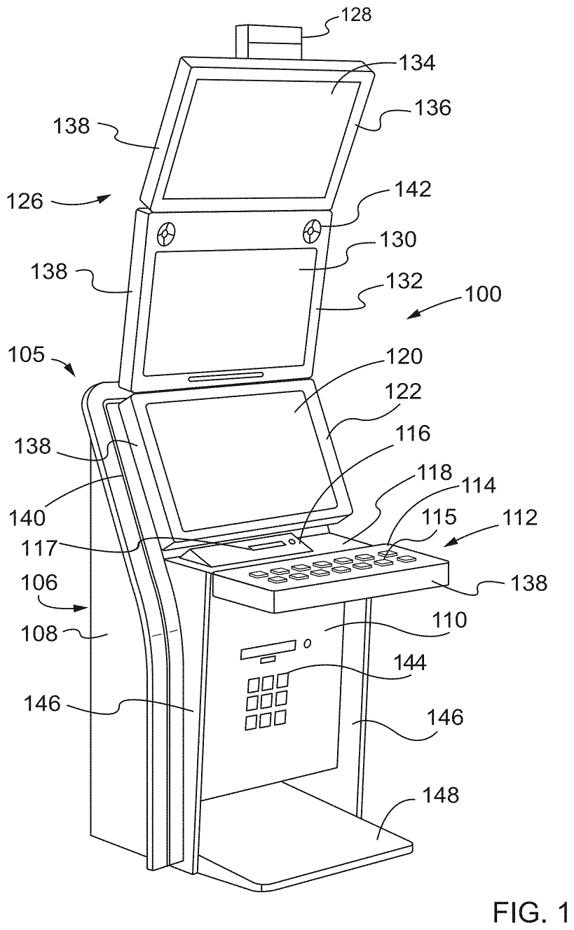

One implementation of a gaming system platform is shown in FIG. 1 where a gaming system 1000 is generally shown. In one implementation, the gaming system 1000 is referred to as a slot machine and is illustrated as housed in a housing or cabinet constructed so that a player can operate and play the gaming system 1000 while standing or sitting.

Gaming system 1000 may include cabinet 105 for housing the components fully described hereinbelow. The cabinet 105 has a lower cabinet body portion 106 which includes a pair of cabinet side panels 108 (only one of which is viewable in the perspective view of FIG. 1), front panel 110, and a rear panel (not shown). A base panel (not shown) and a top panel surface (not shown) that supports first game display 120 and the player interaction area 112, are provided. The cabinet panels are interconnected along their edges and cooperate to form a cabinet enclosure for housing the gaming system, as can be seen in FIG. 1.

It should be appreciated that a wide variety of cabinet enclosure sizes, shapes, and designs are possible for the gaming system 1000. Cabinet 105 may function to securely protect any local control system, technology components, and provide support for game display(s) and player input and output interactions with the gaming system.

Returning to FIG. 1, the gaming system enables the player to interact with the gaming system 1000 to direct the wagering and game play activities and preferences. Various forms of player interaction devices and activities will now be described.

Cabinet 105 includes a player interaction area having input and output areas generally designated as 112. The player interaction area 112 may be located on the front top side of cabinet 105 and, as shown, on a panel structure that extends outwardly from the gaming system in a player's direction. Player interaction area 112 may contain a plurality of player input and output structures such as player control button area 114, player value acceptor and dispenser area 116, and player convenience input area 118.

Player control button area 114 includes a plurality of buttons, touch sensitive areas, or both through with which players may interact with the one or more processors of gaming system 1000 and direct game play. It is expected that cabinet 105 provides an easily accessible location and support for all necessary player input/output (I/O) interactions with the device, including gaming control interactions and value wagering interactions. Although the gaming system 1000 illustrated in FIG. 1 shows player controls provided by buttons of player control button area 114, it is understood that in one implementation, a player's gaming control interactions could be made by either buttons mounted on cabinet 105 or “soft” buttons located on the gaming display and activated by player touch (e.g., touch screen interfaces), or a combination of both arrangements.

Player control button area 114 may include, for example: game selection button(s) in any implementations where more than one game is provided in a single gaming system; gaming denomination value selection button(s) in any implementations where one or more wagering denomination value is accommodated; wager selection button(s) for the player to indicate or select the desired wager value for a game in any implementations where a selection of wager values are offered; pay line selection button(s) for selecting the number of active pay lines in game implementations that provide multiple pay line wagering; a reel spin button for players to initiate one or more reels to spin in a game; a repeat last bet button for players to conveniently repeat the last game's preference and wager selections in a new game; a cash-out button for player extraction of gaming system credits; an attendant call button; and gaming system information buttons such as show pay tables, show game rules, or show other game-related information. As discussed above, the functions of the buttons in player control button area 114 may be duplicated with soft buttons in the player control button area 114 or as soft buttons in other areas of the gaming system 1000 (e.g., as a touch screen overlay over available game displays).

Gaming system 1000 may include one or more forms of value acceptance and value distribution to allow the player to interact with the device and to risk or otherwise place a wager (a monetary value) on one or more outcomes of a game. Winnings may be returned to the player via some form of value distribution. As illustrated in FIG. 1, player value acceptor and dispenser area 116 is provided. In the player value acceptor and dispenser area 116, a player supplies monetary value to the gaming system 1000 via one or more value acceptor devices. In one implementation, the player value acceptor and dispenser area 116 (through the one or more value acceptor devices) may accept any one or more of the following from a player to establish a gaming credit balance: coins, bills, tokens, tickets/vouchers, player ID cards, credit cards, or other suitable forms of value. Thus, if the gaming system 1000 accepts coins and bill, the gaming system 1000 includes a currency bill validator and a coin validator as the value acceptor devices. Likewise, if the gaming system 1000 accepts tickets, the gaming system includes a ticket acceptor as a value acceptor device for receiving tickets or vouchers representing some monetary value. The ticket acceptor may include a bar code reader, or other appropriate code reader, for reading the encoded value contained by the player's ticket or voucher. In some implementations, the player value acceptor and dispenser area 116 may include a value acceptor device that can accept more than one type of value. In some implementations, the player value acceptor and dispenser area 116 may include multiple different value acceptor devices to accept different types of value from players.

Upon receipt of some type of value from the player, a value acceptor device of the player value acceptor and dispenser area 116 performs validation on the player supplied value using appropriate hardware readers (e.g., determining that the currency bills/coins/tokens are genuine or the ticket/voucher is genuine). If the validation result is positive on player supplied value, the appropriate value acceptor device generates a signal to a processor of the gaming system 1000 to establish a gaming credit balance for plays of one or more games on gaming system 1000.

In one implementation, a player receives monetary value, or a representation thereof, from the gaming system 1000 when a player chooses to “cash out” the gaming credit balance (e.g., remove value from the gaming system 1000). The player can cash out at any suitable time. When a player cashes out the value contained on a credit meter (not shown) of gaming system 1000, a processor of gaming system 1000 may cause a printer of gaming system 1000 to print and dispense a coded ticket or voucher through a dispensing slot to the player. The coded ticket or voucher may be a bar-coded ticket or any other suitable code (PDF417 coding or quick response (QR) coding). This ticket can then be used as value input at another gaming system, or converted to currency at a conveniently located kiosk or cashier counter located near the gaming system. Alternatively, the processor of gaming system 1000 may cause a currency bill dispenser or a coin dispenser in gaming system 1000 to dispense the value contained on the credit meter of gaming system 1000.

Various combinations of the above value acceptance and value distribution arrangements are possible. Gaming system 1000 may include other value acceptance and value distribution mechanisms in the player value acceptor and dispenser area 116. For example, gaming system 1000 may include a magnetic strip or chip card reader/writer in order to accept value from and transfer value to a magnetic strip or an embedded chip card. In other implementations, hardware for transferring (and receiving) non-traditional currencies to players such as digital currencies (e.g., bitcoin) may be included in gaming system 1000.

In an alternative implementation, gaming system 1000 may include a card reader (not illustrated) in the in the player value acceptor and dispenser area 116, which accepts and reads any of a variety of magnetic strip or imbedded chip smart cards that convey machine readable information. The card reader reads inserted cards, in the case of wagering, for the credit information of the player for cashless gaming. The card reader may, for player loyalty programs, utilize the information on the card to identify the player account associated with the card so the gaming activity on the gaming system may be associated with the player account. It is noted that a numeric or alphanumeric keypad may be provided adjacent to the card reader slot to enable player entry of a personal identification number or the like for secure access to card information.

In one implementation, a player convenience input area 118 may be included in the gaming system 1000, as is shown in FIG. 1. In various implementations, player convenience input area 118 may have a variety of features and functions depending on the jurisdictional deployment of the gaming system 1000. In one implementation, the player convenience input area 118 will house a magnetic strip card reader (not illustrated), integrated circuit chip card reader (not illustrated), or both, for reading cards associated with a player loyalty program. Player loyalty programs, also referred to as player tracking systems, provide magnetic strip or chip cards to players for insertion into a gaming system during play. These player loyalty/player tracking cards are associated with a player account and are utilized by the card-issuing entity to monitor, or track a player's gaming activity and build loyalty through player rewards of a variety of types. The player convenience input area 118 may include an input mechanism such as input buttons so that a player may input a personal identification number or other require player information associated with the player tracking card. Further, the input mechanism may also include a small display utilized to communicate player information to the player such as the player's current loyalty rewards.

In certain implementations, the player convenience input area 118 may include player convenience features such as a pocket for storage that allows players to store their personal items such as a mobile phone. Gaming system 1000 may include one or more universal serial bus (USB) ports that enables a player to charge their electronics or connect to services such as the Internet or food service. Further, player convenience input area 118 of gaming system 1000 may include buttons to request food or drink service if the gaming system is located in an establishment that has food and drink service. The gaming system 1000 may be connected to a local or wide area network such that selection of the requested food or drink service will alert the establishment's hospitality staff to deliver the requested service directly to the gaming system 1000.

The layout of the player control button area 114, player value acceptor and dispenser area 116 and the player convenience input area 118 in gaming system 1000 may be arranged differently than those disclosed and illustrated herein. The selections and arrangement of input locations on the cabinet 105 may be dependent upon the game buttons, the type of value wagered, and the player conveniences utilized in the deployment configuration of gaming system 1000.

With continuing reference to FIG. 1, in one implementation, lower cabinet body portion 106 includes a first game display 120 mounted atop or flush with the lower cabinet body portion's top panel surface. First game display 120 is, for example, a 27-inch liquid crystal display (LCD) display mounted in a widescreen orientation. However, any suitable display may be used in any suitable orientation. In the illustrated implementation, the first game display 120 is mounted within and framed by first display frame 122 which is, in turn, mounted upon lower cabinet body portion's top panel surface. In this manner, the first game display 120 is both surrounded and secured within the first display frame 122 and raised above the cabinet's top panel surface. Additional features of the first display frame 122 will be described below. In one implementation, gaming system 1000 may use one first game display 120 and not include additional game displays (not illustrated).

The lower cabinet body portion 106 is further constructed to support upper cabinet portion 126. Upper cabinet portion 126 may be comprised of an upwardly extending support structure (not illustrated) that extends upwardly from the rear side of lower cabinet body portion 106 and is sufficiently strong to support one or more additional game displays.

At the topmost end of the support structure, a cabinet top light 128 may be provided. The cabinet top light 128 is capable of illumination in a variety of colors and is utilized to indicate and communicate gaming system conditions to gaming players and service personnel.

Further, the upper cabinet portion support structure may conceal power and communication lines between (1) the control systems and components located within the lower cabinet body portion 106 and (2) the displays mounted on the upper cabinet portion 126 support structure.

In one implementation, as illustrated in FIG. 1, gaming system 1000 includes two additional displays, second game display 130 and third game display 134. Second game display 130 and third game display 134 are disposed generally in a vertical relationship and generally in alignment with the first game display 120. Like the first game display 120, second game display 130 and third game display 134 can be 27-inch LCD displays and can be mounted in a widescreen orientation in one implementation. However, any suitable display in any suitable orientation may be used for the second game display 130 and the third game display 134. Further, like the first game display 120, second game display 130 and third game display 134 can be mounted within and framed by second display frame 132 and third display frame 136, respectively. Second display frame 132 and third display frame 136 are attached to the upper cabinet support structure and can protect the second game display 130 and the third game display 134.

First game display 120, second game display 130, and third game display 134 can be disposed at an angle from each other to form a player-facing concave arc. However, in some implementations, the angles between the displays may be adjustable and may be smaller or greater than the angles illustrated in FIG. 1. Further, it is understood that in some implementations the displays may be disposed in a common plane relative to each other.

It also should be appreciated that in various implementations a variety of display technology may be utilized equivalently and interchangeably with a variety of implementations of the gaming system. Equivalent display devices include all variations of liquid crystal displays, light emitting diode displays, and plasma displays.

In some implementations, different sized displays may be combined to display gaming data on gaming system 1000. As a non-limiting example, a 27-inch widescreen LCD display may be combined with a 20-inch portrait oriented LCD or a light emitting diode (LED) display. This combination may be used, for example, with a third scrolling banner LED display. In alternative implementations, one, two, three, or more displays could be used in a variety of positions and orientations. Any suitable combination may be used. It should also be appreciated that a processor of gaming system 1000 may communicate with the disclosed first game display 120, second game display 130, and third game display 134 through a video card of gaming system 1000 to produce the visible aspects of a game.

In one implementation, one or more of the first game display 120, second game display 130, and third game display 134 may be fitted with a transparent touch sensitive overlay for sensing player touch inputs into the gaming system. Touch sensitive overlays can communicate with a processor of gaming system 1000 to enable the player to interact with the game.

In some implementations, the curved displays may be used for any or all of the first game display 120, second game display 130, or third game display 134. Similarly, any of the displays used for gaming system 1000 can be based on flexible display technologies. For example, it is possible to utilize flexible display technologies to create uniquely shaped curving, wavy, or tubular display structures to provide one or more of the first game display 120, second game display 130, and third game display 134. Additionally, in one implementation flexible display technologies can be used in combination with fixed flat screen technologies.

While the gaming system 1000 has been described as implemented with video technologies, in one implementation, mechanical reels with reel strips containing game indicia and step motor controllers may be employed to provide game information to a player. In one implementation, the reel strips may include a plurality of printed symbols. In another implementation, the mechanical reels may include flexible video display technology as the reel strips on mechanical reels. Thus, games implemented in video form can readily be implemented with mechanical reels utilizing such display technology. Alternatively, in other implementations mechanical reels with reels strips having fixed symbols displayed along the reel strip could be used to implement the game.

Dependent upon the particular gaming system housing style, a variety of other display technologies may be utilized in combination with the gaming system disclosed herein. For example, in some implementations a gaming system may have one or more display devices in addition to the main game display(s). For example, the gaming system may include a player tracking device having a player tracking display which displays various information to the player regarding the player's status. The gaming system may also include other game-related displays such as the wager display and the gaming credit balance display. These additional game-related displays may be separate display devices or may be displayed on any one or more of the first game display 120, the second game display 130, or the third game display 134.

Cabinet lighting design functions to attract players to a gaming system 1000. In the implementation of FIG. 1, attractive cabinet lighting is provided by frame accent lighting 138. It is noted that frame accent lighting 138 is a common structure found on each of the first display frame 122, the second display frame 132, and the third display frame 136 and player interaction area 112. Example areas where frame accent lighting is applied to gaming system 1000 are commonly designated as frame accent lighting 138.

Frame accent lighting 138 may have multiple components. The side edge pieces of first display frame 122, second display frame 132, third display frame 136, and the edge structure of player interaction area 112 can be made of a translucent or transparent plastic or other suitable materials. Linear arrays, or strips, of light emitting diodes (LEDs) (not shown) on circuit boards may be mounted below the translucent or transparent plastic side edge pieces 138. In one implementation, the circuit boards are flexible circuit boards. These LED strips and transparent or translucent coverings may surround one or more gaming system displays frames, as well as the player interaction area, to highlight these areas.

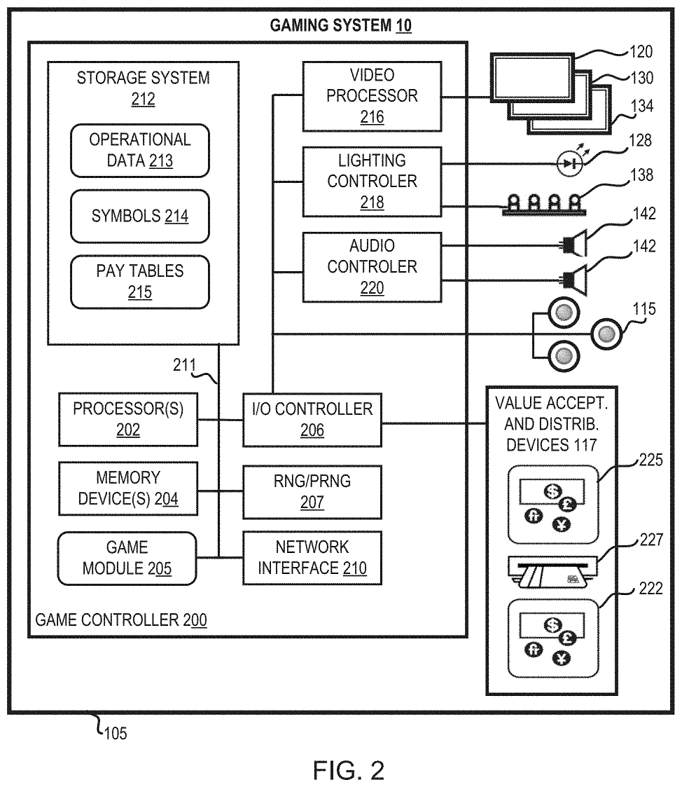

In one implementation, the individual LEDs mounted on the LED strips are of a type that can emit red, green, and blue light. In an alternative implementation, separate LEDs are used for each required light color. All LED strips can be electrically connected and can be controlled by a cabinet lighting controller 218 (illustrated in FIG. 2) in conjunction with a processor of gaming system 1000 to selectively mix the emitted light colors in a manner to create any color. The cabinet lighting controller 218 can flash and vary lighting as desired. For example, cabinet edge lighting can change and flash in combination with music rhythms or in combination with game events. Other variations are possible.

In some implementations, cabinet 105 may include LED strip lighting or LED rope lighting to accentuate the cabinet and enhance the attractiveness of gaming system 1000 to players. LED rope lighting is a plurality of small light-emitting diode bulbs linked together and encased in a plastic, polyvinylchloride, or other suitable material to create a string of lights. For example, in the implementation of FIG. 1, cabinet 105 includes cabinet accent lighting 140. In one implementation, cabinet accent lighting 140 is LED rope lighting mounted flush with the front side edge of the cabinet side panels 108. The LED rope lighting can generate any of suitable colors, and are controlled by cabinet lighting controller 218 and a processor of gaming system 1000 to selectively mix the emitted light colors in a manner to create any color in the same manner as the frame edge lighting.

In various implementations, gaming system 1000 includes one or more audio speakers and appropriate driving electronics and sound cards so that game players may experience pleasing audio aspects of the gaming system 1000. Audio is desirable to attract and maintain player interest in gaming system 1000. Gaming system 1000 may also emit attraction sounds during any idle period of gaming system 1000. Game audio may add to the player's enjoyment of gaming system 1000 by providing music and sound effects designed to enhance and compliment the gaming experience.

Audio speaker hardware may include one or more speakers disposed in or on the cabinet 105 of gaming system 1000. In FIG. 1, a pair of audio speakers 142 are shown mounted on the upper corners of second display frame 132. Any suitable number of additional speakers may be provided on additional display frames or on the lower cabinet body portion 106 as desired.

Speakers designed for emitting bass vibrations may be included in some implementations. Speaker placement may be selected to enhance the sound emitting characteristics of the gaming system. For example, bass speakers or additional speakers 144 may be mounted inside lower cabinet body portion 106. Further, it is envisioned that in some implementations sound processing such as multichannel processing and surround sound processing are included in gaming system 1000. Audio jacks for attachment of player headphones may also be provided in some implementations of gaming system 1000 for the player to further enhance the audio experience of the game and also to block out noise from other gaming systems.

In one implementation, front panel 110 of lower cabinet body portion 106 includes a locked removable panel or locked door (not shown), which can be opened for access to internal control system and technology components that are housed within lower cabinet body portion 106 (discussed hereinbelow with respect to FIG. 2). Front panel 110 may be flanked on vertical sides by cabinet side panel extensions 146 which serve to define a space below player interaction area 112 for players to place their feet and legs while they are playing gaming system 1000 in a seated position. Foot rest 148, which may be cushioned, is provided below player interaction area 112 to enhance a player's ergonomic comfort while playing gaming system 1000. In one implementation, the edges of player interaction area 112 may be ergonomically cushioned as well.

Gaming system 1000 may be embodied in alternative gaming system housing forms and styles. For example, the housing may have fewer or greater number of display areas for displaying the game and game-related information to the player. If multiple displays are used, the displays may be of similar size, shape, and orientation or the displays may be divergent from each other in one or more of their respective descriptive characteristics. The one or more displays can be supported by, mounted upon, or housed within a cabinet 105 which can comprise a variety of shapes, sizes, and forms. The cabinet 105 can 1) protect and house the operational electronics, 2) adequately support the display(s) in a position easily viewable for a seated or standing player, as necessary 3) provide an easy location and support for all necessary player input/output (I/O) interactions, including gaming control interactions and value wagering interactions. For example, in some implementations the gaming system 1000 may be disposed in a housing style referred to as a “slant top” gaming system that is designed to be operated with the player comfortably seated. In this arrangement, generally, the gaming display(s) and all player I/O controls are located on a low, wide, surface that extends forwardly from the player on a horizontal plane and then slopes upwardly and away from the player's seated location.

In one implementation, housing styles of cabinet 105 of gaming system 1000 may include bar top or table top housing arrangements. These housings are generally small enough to be placed on top of an existing bar or table while providing the requisite gaming system housing functions of protection of/access to gaming electronics, displays, and player I/O functions described above.

In one implementation, cabinet 105 may be an embedded housing. Embedded housings are built into structures designed to otherwise function as bars or tables in a gaming environment. Displays may be integral with the bar top or table top surface or the entire unit may be contained below a transparent bar or table top surface while controls are disposed on the lower front or side of the bar or table.

FIG. 2 shows a functional block diagram illustrating an example of a game controller 200 of a gaming system 1000 in accordance with aspects of the present disclosure. The gaming system 1000 can include a cabinet 105, one or more player input devices 115, one or more value acceptance and distribution devices 117, one or more display devices 120, 130, and 134, a cabinet top light 128, accent lighting 138, and one or more audio speakers 142, which can be the same or similar to that previously described herein. Additionally, implementations of the game controller 200 may include one or more processors 202, one or more memory devices 204 (e.g., random access memory, read only memory, etc.), one or more game modules 205, one or more input/output (I/O) controllers 206, one or more random number generators 207, one or more network interfaces 210, one or more communication channels 211 (e.g., a data bus), one or more video processors 216, one or more lighting controllers 218, and one or more audio controllers 220. In accordance with aspects of the present disclosure, the game controller 200 is configured to perform specialized game functions and operations, consistent with the implementations described herein. The functional elements shown in FIG. 2 cooperate, on a broad and general level, to function as a gaming system providing the functionality and operations detailed below. Such functionality and operations can be embodied in hardware, software, or a combination thereof. It is understood that the below described hardware includes the structures described, as well as the functional or operational equivalents of such structures. Further, it is understood that the below-described functions and operations can be performed by hardware, digital circuitry, computer software, computer firmware, or functionally equivalent combinations thereof.

The processor 202 can be one or more general-purpose processors, special-purpose processors, or other programmable data processing apparatuses providing the functionality and operations detailed herein. In some implementations, the processor 202 is specially configured with arithmetic logic units and math co-processors, also known as floating point units, for executing one or more games consistent with the various implementations disclosed herein. In some implementations, the processor 202 includes registers for holding instructions or other data, and cache memory for storing data for faster operation thereupon.

A controller, in some implementations, is a device or a software program that manages or directs the flow of data between two entities. Often, controllers are special purpose circuitry or software that solve a technical communications problem between different technology systems. In some implementations, a controller functions as an interface between two systems while managing the communications between the systems. In another implementation, a controller functions as an interface between a processor and a peripheral device and functions to control the peripheral device.

The memory device 204 and storage system 212 can be operatively and/or communicatively connected to the processor 202. In some implementations, the memory device 204 and/or the storage system 212 includes one or more types of memory structures. For example, the memory structures can include random access memory (RAMs) units, read only memory (ROMs), flash memory (e.g., solid state drives (SSDs)), electrically erasable/programmable read only memory (EEPROMs), etc. It should be appreciated that in some implementations, communication between the memory device 204, the storage system 212, and the processor 202 or another controller, encompasses the processor or controller accessing the memory device 204 and/or the storage system 212, exchanging data with the memory device 204 and/or the storage system 212 (e.g., reading/writing data to the memory device 204), or storing data to the memory device 204 and/or the storage system 212.

The memory device 204 and/or the storage system 212 may store program code, game code (collectively the “code” or “program instructions,” such as game module 205), and operational data (e.g., game info 213, symbols 214, and pay tables 215, or other suitable data) used in the operations of the game controller 200 to provide a gaming system that executes the gaming functions described hereinbelow. In an alternative implementation, the code and the operational data for the operation of the game controller 200 may be stored in a distributed manner such that some code is stored in memory device 204 (or storage system 212) and other code is stored remotely from the game controller 200. In some implementations, the code and the operational data used the operation of the game controller 200 includes, for example, basic input and output function data, instruction fetching data, bus and network communication protocol data, and like data for an operational gaming system. In some implementations, the code (e.g., the game module 205) and the operational data (e.g., game info 213, symbols 214, and pay tables 215, or other suitable data) used for the execution of the gaming features includes, for example, game image data, game rule data, pay table data, game mode and timing data, gaming value and wager parameter data, and random or pseudo-random number generation data.

In addition to the memory device 204 described above, in some implementations, the code and operational data for the operation of the gaming system described above may be stored in the storage system 212. The storage system 212 can be removable game cartridges or flash drives, a compact disk ROM, a digital versatile disk (DVD) optical storage technology, or suitable other fixed, non-transitory computer-readable storage devices. In some implementations, part or all of the code and operational data for operation of the gaming system or for execution of the game features may be stored in a remote memory structure and be downloaded to the memory device 204 via a network connection.

In some implementations, the game controller 200 may utilize any combination of computer-readable memory devices, such as random-access memory devices (RAMs), unalterable memory devices (ROMs), and mass storage devices for securely storing and securely communicating the software components or code that facilitate game play and other functions of the game controller 200. The memory device 204 may store software components or code that include various game data and game related control and execution software. In some implementations, the software components stored in the memory device 204 may include gaming system initialization software, system basic input and output software, operating system software, value acceptor software, value dispenser software, display image generation software, symbol set image generation software, game rule execution software, game data set(s), random number generation software, system driver software, system data bus management software, audio generation and speaker driver software, and video generation and display driver software, and any other suitable software routines for operation of the game controller 200.

In some implementations, the memory device 204 and the storage system 212, with the software components, code, operational data, and other information may be secured and authenticated by authentication software stored in an unalterable memory device within the housing of the game controller 200. The game controller 200 may also include application specific integrated circuits (ASICs) to perform the security and authentication functions. At various time or events, such as before each play of a game, at a predetermined interval, upon transfer of any game data or any software components from a mass storage to the memory device 204, or upon demand, the game controller 200 (using a processor such as a processor 202 or a separate ASIC) may execute an authentication routine and perform an authentication of any software component or other data of the game controller 200. In some implementations, the software components of the gaming system 1000 and game controller 200 may be prepared for authentication via creation and storage of an encrypted signature unique to one or more of the software components.

In some implementations, an encrypted signature may be created by utilizing a hash function on a software component or code to form a message digest (e.g., a hash of the software component) followed by a key encryption of the message digest to form an encrypted signature unique to the software component. In some implementations, the key encryption may be public key encryption, private key encryption, or any suitable key encryption schema. The encrypted signature may be stored with the gaming system software component, for example, in a mass storage device or an unalterable memory. During a software component authentication, the gaming system 1000 executes one or more authentication routines utilizing the same hash function to operate on the software component to compute, or re-create, a new message digest for the software component. The new or re-created message digest may then be compared with a previously created message digest obtained by decrypting the stored encrypted signature. Matching message digests between the new and previously created message digests indicate that the software component is authentic and the game controller 200 may allow game play to proceed. In some implementations, when the message digests do not match, the game controller 200 may determine that the software component under authentication may be corrupted or fraudulent and game play may be halted. It should be appreciated that the game controller 200 may perform other suitable security and authentication checks on the game data or software components. Such authentication and security devices and functions are unique to gaming and casino industry to minimize or prevent fraud in gaming devices and gaming systems.

For a player to interact with the gaming system 1000, the game controller 200 receives and processes player inputs from, e.g., input devices 115, and the game controller 200 causes processed results to be output or communicated to the player. In some implementations, the player inputs are recognized and processed or directed for processing by input/output (I/O) controller 206. Further, the I/O controller 206 may process and direct player outputs for communication to the player. The I/O controller 206 can function as the intermediary between the processor 202 and one or more input devices to control information and data flow therebetween. The I/O controller 206 may also function as the intermediary between the processor 202 and one or more output devices to control information and data flow therebetween. The I/O controller 206 is configured to understand the communication and operational details (such as hardware addresses) for the attached input devices and output devices. In this manner, processor 202 can be freed from the operational details of the peripheral I/O devices in some implementations. For example, in some implementations where an input or output device is changed or upgraded, the I/O controller 206 can be changed or updated without changing other gaming system components.

In some implementations, a player deposits value into a gaming system by inserting some form of currency or value into a value acceptor 225 for game play. Alternatively, a player deposits value into a gaming system by inserting an encoded paper ticket into a value acceptor 225 for game play in some implementations. The value acceptor 225 can be combined with a currency reader and validator, and a code reader for reading value encoded on paper tickets. In some implementations, the gaming system 1000 may include different hardware for the paper ticket reader from the currency reader and validator. The value acceptor 225 may read, validate and communicate the amount of the inserted value to the processor 202. The processor 202 can establish a gaming credit balance for the player based on the communication from the value acceptor 225. The processor 202 can also communicate the player's credit balance on a credit balance meter display of the gaming system 1000. During game play, the processor 202 may process a player's wagers and determine an amount of credits to debit from the player's credit balance. When a winning outcome is obtained, the processor 202 is configured to determine an amount of credits to add to the player's credit balance. It should be appreciated that the gaming system 1000 may use one or more different processors to perform such calculations.

As previously mentioned with respect to FIG. 1, gaming system may use one or more of a variety of value acceptance systems. In some implementations, the value acceptor 225 could include magnetic strip or chip card readers to accept and transfer value. The value acceptor 225 may also be configured to accept and transfer non-traditional currencies such as digital currencies. In these implementations, I/O controller 206, a processor 202, or both may be configured with appropriate control instructions to communicate with the value acceptor 225 and extract value from the inserted item containing value. In some implementations, use of a magnetic strip or embedded chip card, for example a bank card, for value insertion requires the processor 202 to communicate, via network interface 210, with devices external to a gaming system 1000.

In some implementations, a card reader 227 may be included in gaming system 1000 to accept player loyalty cards. For example, the card reader 227 can extract account identifying information from the card and utilizes this information to access the associated account information stored remotely via the network interface 210. In implementations where player loyalty/player tracking systems are used with the gaming system 1000, a player's loyalty account and record of gaming activity can be stored in a networked storage location or database. In some implementations, the processor 202 is configured to record the player's gaming activity in the memory device 204 and/or the storage system 212 during the duration of loyalty card insertion. When the loyalty card is removed from the card reader 227, recorded gaming activity is uploaded, via the network interface 210, to the remote storage location associated with the player's account in some implementations. In this manner, the player's gaming activity can be further processed and analyzed, and the player can be awarded loyalty rewards based upon his activity data at the gaming system 1000.

In various implementations, the input devices 115 receive a player's game inputs and communicates the player's game inputs to the processor 202. The player's game inputs may include, but are not limited to, wager amounts, pay line selections, game control signals, game selections, and cash-out requests/signals. In some implementations, the input device 115 may generate signals/requests based on button presses, touch screen activations, or voice control. In some implementations, the player-initiated signals can be communicated to the processor 202 by the I/O controller 206. Further, the player-initiated signals may direct and inform execution of the game instructions stored in the memory device 204 and configured to be executed by the processor 202 in some implementations.

In some implementations, the gaming system 1000 may include mechanical game reels and other electro-mechanical components to provide game displays and game outcomes (not shown). For example, mechanical game reels (e.g., mechanical game reels rotatable about a common axis) may include indicia or symbols fixedly positioned around the periphery of the mechanical game reels. The indicia or symbols fixedly positioned around the periphery of a mechanical game reel may form a reel strip. The indicia or symbols fixedly positioned on reel strip may comprise a set of symbols for that reel strip or reel. The indicia or symbols on the mechanical game reels are generally associated with separate, detectable reel stop positions for the reels. In some implementations, the mechanical game reels can be set into a spinning/rotation motion by pulling a lever or pushing a button of the gaming system 1000. In some implementations, the gaming system 1000 can stop the game reels by allowing the mechanical game reels to stop naturally, or actuating a suitable mechanical or electro-mechanical reel brake on a random timing basis. When the mechanical game reels stop rotating, the gaming system 1000 may, using suitable detection mechanisms, determine one or more displayed stop positions of the mechanical game reels. Since the displayed stop positions of the mechanical game reels can be associated with respective indicia or symbols, the gaming system 1000 can determine what combination of indicia or symbols are displayed at the stop positions. The gaming system 1000 can also determine whether the displayed indicia or symbols result in one or more winning symbols and/or winning symbol combinations for a game outcome.

In some implementations, the displayed stop positions (e.g., corresponding to displayed indicia) can be determined using random numbers associated with the displayed stop positions/indicia/symbols of the mechanical reels. In some implementations, the processor 202 is configured to execute stored program code and instructions which generate random numbers or pseudo-random numbers for determining the displayed stop positions of the mechanical reels. The gaming system 1000 can use the randomly generated numbers to determine which stop positions of the reels should be displayed for a game outcome.

In some implementations, a random number generator (RNG) 207 is a software module configured to be executed by the processor 202 for the generation of a true random or pseudo-random number. The code for RNG 207 may be stored in the memory device 204 or the storage system 212. The RNG 207 generates random numbers for use by the gaming system 1000 during game execution. In some implementations, the gaming system 1000 can utilize the random numbers for the random selection of one or more symbols (e.g., stop positions) along mechanical game reels.

In some implementations, the gaming system 1000 uses video-based reels as simulations of the mechanical reels to provide game displays of game outcomes. In some implementations, the video-based reels are used in place of mechanical reels. In some implementations, the video-based reels are used in conjunction with mechanical reels or other mechanical components. Like a mechanical game reel, a video-based reel can be associated with a reel strip, where the reel strip includes a set of symbols or indicia. The set of symbols or indicia for a reel strip may be fixed or dynamic in various implementations. In some implementations, indicia or symbols can include, but are not limited to, numbers, letters, geometric figures, symbols, images, character, animations, blank symbols (e.g., the absence of symbols), or any other suitable graphical depiction. The gaming system 1000 may include one or more video-based reels for a game. The gaming system 1000 may include a particular reel strip associated with a particular video-based reel. In some implementations, each video-based reel can be associated with a separate reel strip (e.g., a separate set of symbols). The reel strips can be the same or different for different video-based reels. It should be appreciated that the language “reel strip(s)” is used merely for illustration purposes throughout this disclosure. In some implementations, predetermined reels strips may be used. In other implementations, a reel strip is a representation of a set of symbols, where symbols in the set of symbols are associated with a probability of being determined or generated for display in the visible symbol display areas of a video-based reel. Different reel strips (e.g., different sets of symbols) may include the same symbols associated with the same or different probabilities of being determined or generated. In some implementations, different reel strips may include different symbols. It should be appreciated that in some implementations, indicia or symbols can be used independently of a video-based reel. That is, some games on gaming system 1000 may not use video-based reels or reel strips, but use random number determinations for game outcomes.

Returning to random number generation, symbols in the reel strips or sets of symbols can be associated with numbers for video-based reels similar to mechanical game reels. In some implementations, when the RNG 207 selects a number, a processor in conjunction with the memory devices 204 of the gaming system 1000 can correlate the selected number to an associated symbol to determine what symbol has been randomly selected. In various implementations, once symbols are randomly selected based upon the random numbers generated by the RNG 207, the processor 202 can evaluate the displayed patterns of symbols or randomly determined numbers to determine one or more game outcomes. It should be appreciated that in some implementations, gaming system 1000 may include a hardware based random number generator that is in communication with processor 202 to supply random numbers for random symbol determination purposes. The hardware based random number generator may be incorporated into the processor 202 or can be separate from the processor 202.

Returning to FIG. 2, the game controller 200 controls the function and output of output devices utilized by a gaming system. In various implementations, the I/O controller 206 serves as an interface unit between the processor 202 and output devices, such as video processor 216, cabinet lighting controller 218, audio controller 220, and value dispenser 222.

In some implementations, the video processor 216 communicates with the processor 202 to render at least some of the game graphics, video displays, and information on one or more video display devices (e.g., game display devices 120, 130, and 134). In some implementations, the video processor 216 includes one or more processors, controllers, and/or graphics cards for processing the game images, outcomes, and animated displays and coordinating the processed data to be display between, among, or across any or all display devices. In various implementations, this may include being configured to simulate objects and the movement of objects which represent video game reels containing symbol sets.

It should be appreciated that in certain other implementations where gaming system 1000 includes physical mechanical game reels to display symbols or other game features, reel controllers and stepper motors can be provided in lieu of or in addition to video processor 216.

In implementations which utilize cabinet lighting as described with respect to FIG. 1, a cabinet lighting controller 218 may be utilized to coordinate and control the color and timing of cabinet lighting displays with processor 202. In certain implementations which utilize sound design, processor 202 may utilize audio controller 220 to coordinate and control the sound emissions. In some implementations, audio controller 220 may include one or more audio processing cards for generating sound and for driving the one, two or more speakers 142 that may be included with the gaming system 1000.

In various implementations, players may request their remaining credit value by selecting one of the input devices 115, which in turn makes a request or initiates a signal that is communicated to the processor 202, such as via the I/O controller 206. In some implementations, the signal triggers a readout of the player's credit balance from a credit balance meter and the processor 202 initiates a value dispensing signal which, in turn, can be communicated to the value dispenser 222. In some implementations, the value dispenser 222 can be controlled to issue the player's credit value using any of the types of value discussed herein. In some implementations, the player's credit value may be issued to the player via a printed and dispensed encoded paper ticket or token which the player can then exchange at a special purpose kiosk or cashier location for the monetary value encoded into the ticket or token. In some implementations, the processor 202 can direct the value dispenser 222 to issue to the player an appropriate amount of coin or bills directly to the player. Additionally, or alternatively, in some implementations, the player may have the option to electronically direct the credit value to an account associated with the player. It should be appreciated that any suitable combination of forgoing may be available at gaming system 1000.

In some implementations, the game controller 200 may communicate with one or more devices outside the gaming system 1000. For example, gaming system 1000 may be connected to a larger network via a local area network (LAN) or a wide area network (WAN). The game controller 200 may communicate with one or more central servers, controllers, or remote devices to execute games, establish credit balances, participate in progressive jackpots, etc. In some implementations, network communications and connections can be accomplished via a network interface 210. Network interface 210 can be a digital circuit board or card installed in game controller 200 to provide network communications with external devices. Network interface 210 may include wired and/or wireless communication hardware.

In some implementations, various additional features and functions are performed by the game controller 200. For example, the game controller 200 may be specially configured with software to track game play events that occur on the gaming system 1000. In some implementations, the game controller 200 may audit recorded monetary transactions, including wager amounts, game outcomes, game winnings, and game payouts that occur through the value dispenser 222. Further, some implementations of gaming system may include security software to assist in protecting the gaming system 1000 from tampering or alteration attempts.

### Gaming System Operation

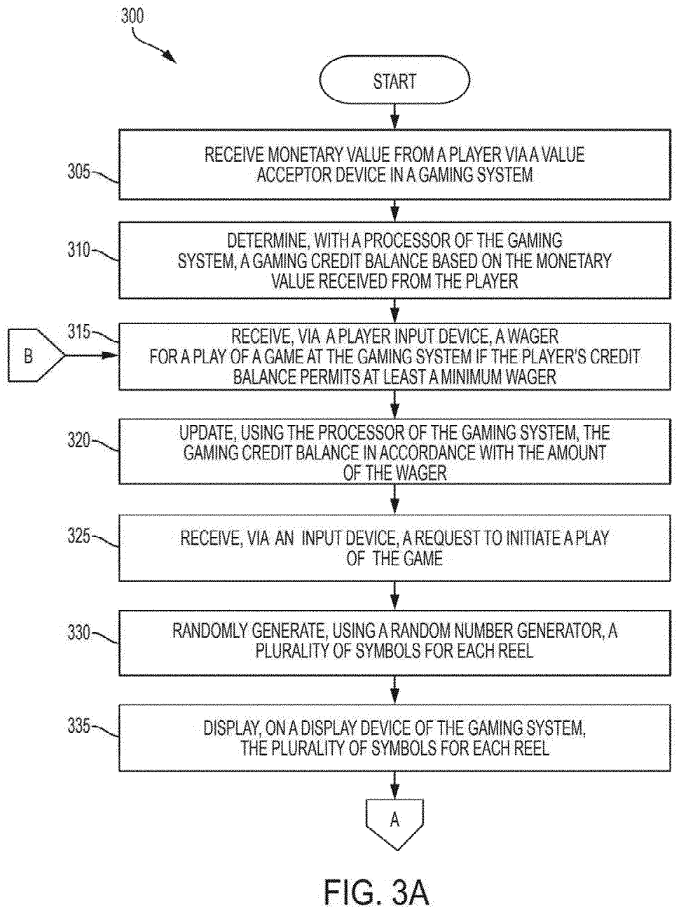

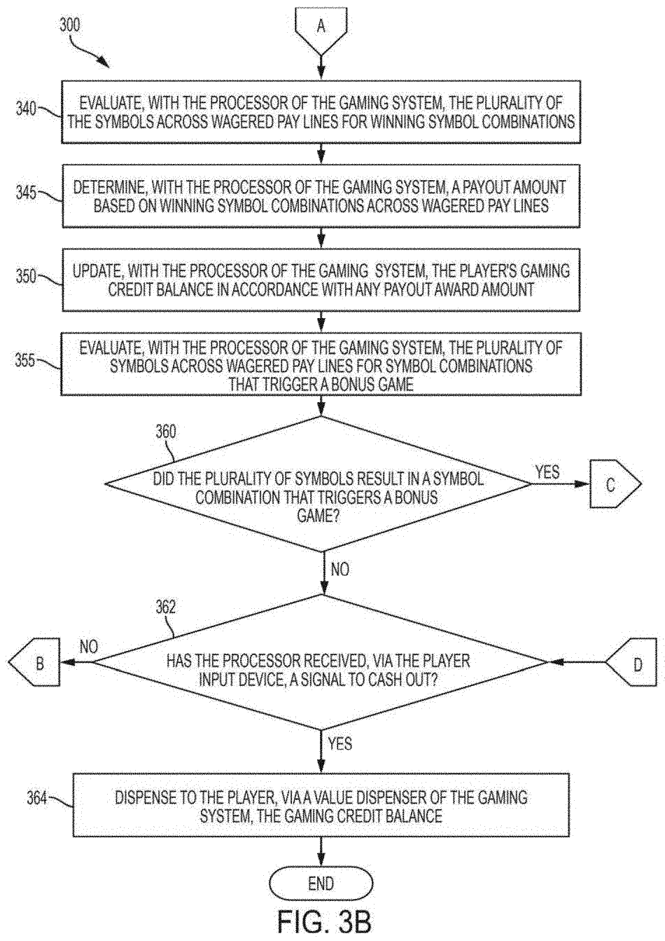

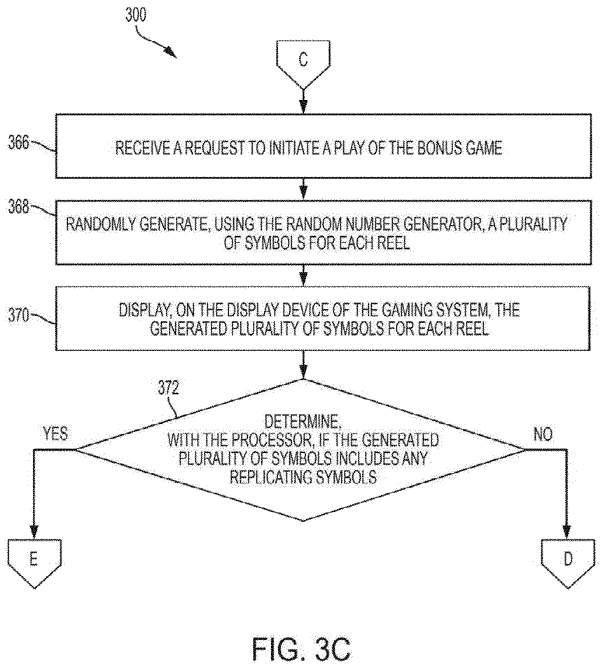

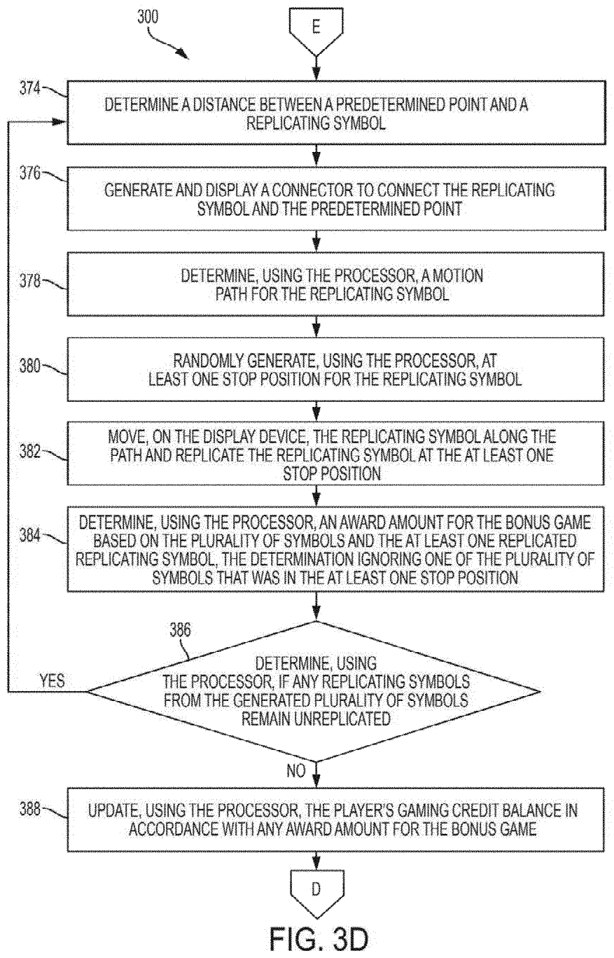

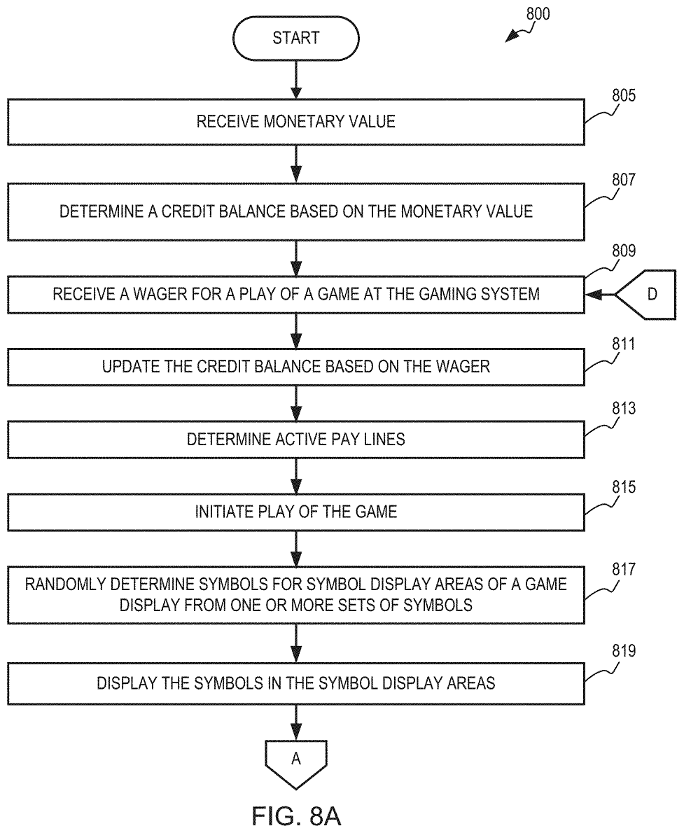

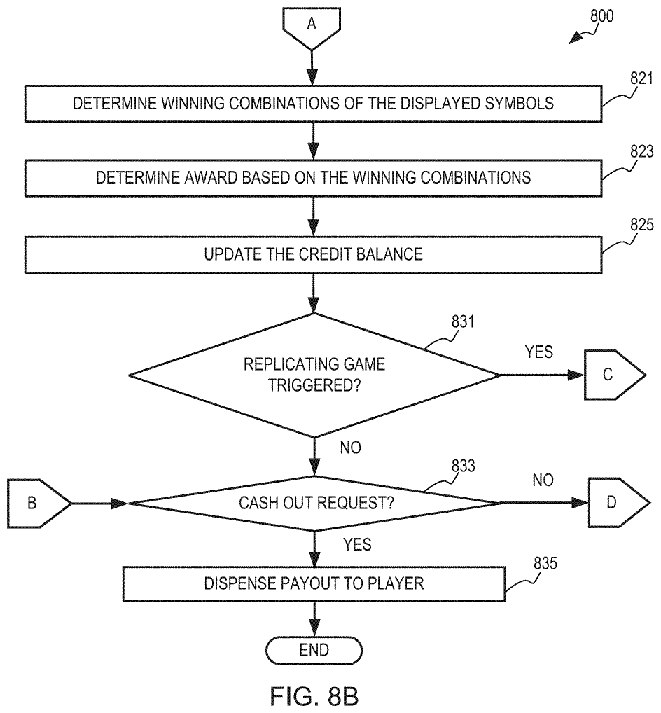

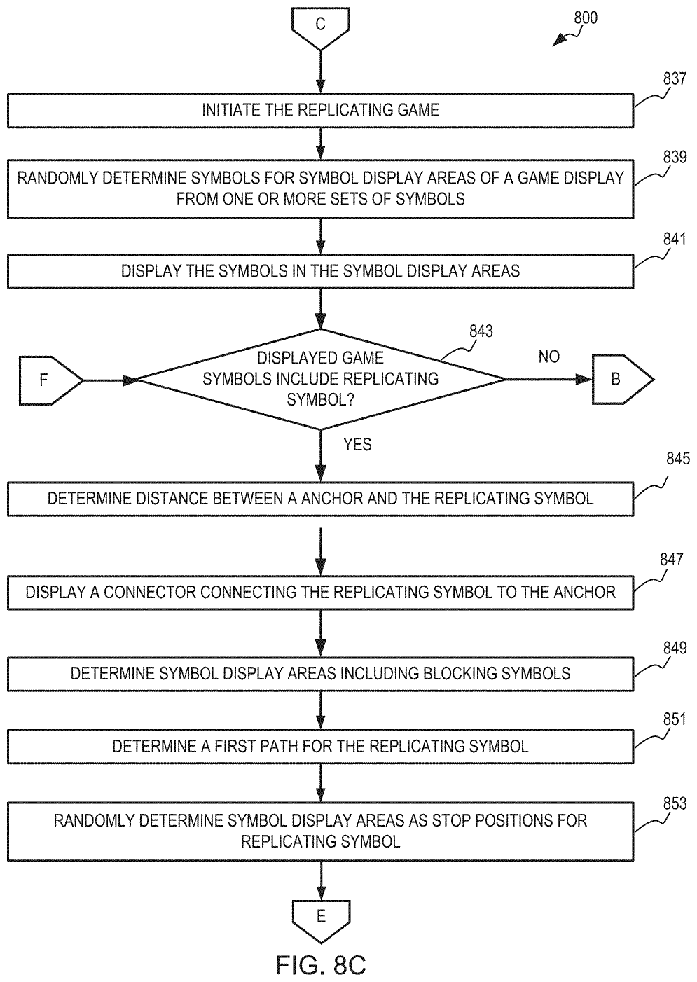

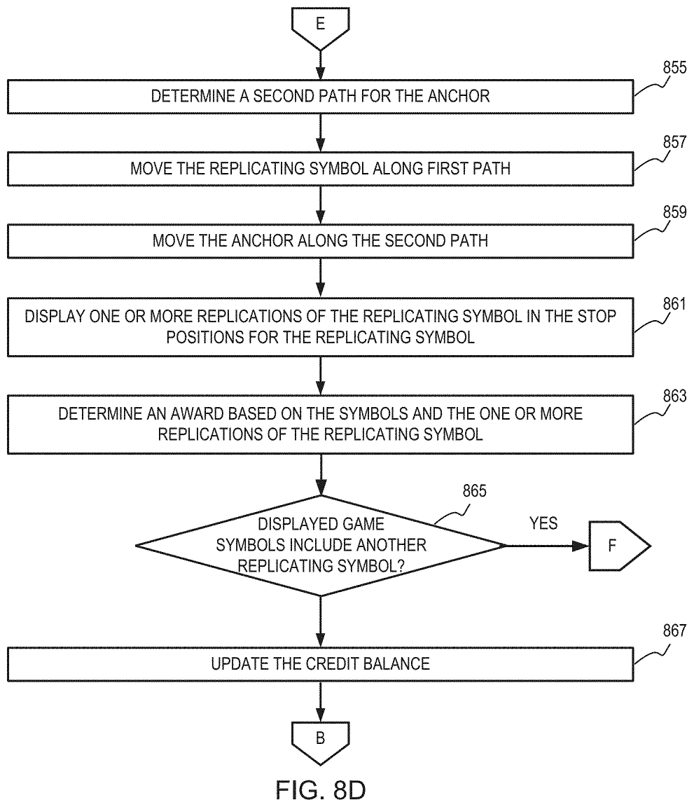

The flow diagrams in FIGS. 3A-3C and 8A-8D illustrate functionality and operations of systems, devices, processes, and computer program products according to various implementations of the present disclosure. Each block in FIGS. 3A-3C and 8A-8D can represent a module, segment, or portion of program instructions, which includes one or more computer executable instructions for implementing the illustrated functions and operations. In some implementations, the functions and/or operations illustrated in a particular block of the flow diagrams can occur out of the order shown in FIGS. 3A-3C and 8A-8D. For example, two blocks shown in succession can be executed substantially concurrently, or the blocks can sometimes be executed in the reverse order, depending upon the functionality involved. Additionally, in some implementations, the blocks of the flow diagrams can be rearranged in different orders. Further, in some implementations, the flow diagram can include fewer blocks or additional blocks. It is also noted that each block of the flow diagrams and combinations of blocks in the flow diagrams can be implemented by special-purpose hardware-based systems that perform the specified functions or acts, or combinations of special-purpose hardware and computer instructions.

FIGS. 3A, 3B, 3C, and 3D illustrate a flowchart of an example operation 300 of one implementation of the gaming system and method. FIGS. 3A and 3B are depicted as a base or primary game while FIGS. 3C and 3D are depicted as a bonus game. However, it should be appreciated that FIGS. 3C and 3D may be integrated as part of a base game without entering a separate bonus game. FIGS. 3C and 3D may be used in a standalone base game.

In one implementation, a processor of the gaming system is configured, via instructions stored in a memory device, to perform the operation 300. However, it should be appreciated that other suitable variations of operation 300 are possible. For example, in one implementation, fewer or one or more additional blocks (not shown) may be employed in operation 300 of the gaming system and method. In other implementations, the blocks may be performed in any suitable order.

FIG. 3A illustrates one implementation in which the gaming system receives a monetary value from a player to initiate operation 300. As indicated in block 305, the gaming system may receive monetary value via a value acceptor device associated with the gaming system. The value acceptor device, in one implementation, is disposed in a gaming system or in communication with the gaming system as discussed above.

In one implementation, the gaming system determines a credit balance based on the monetary value received from the player at a value acceptor device as indicated in block 310. The gaming system determines, via a processor, a gaming credit balance for the player. The gaming credit balance may be based on the monetary value received from the player at the value acceptor device.

In one implementation, the gaming system may receive a wager for a play of a game at the gaming system. Block 315 of FIG. 3A illustrates one implementation where the player's wager is received via a player input device. The gaming system may allow a player to place a minimum wager, a maximum wager, or any suitable wager amount. Depending on the wager amount, the gaming system may also enable the player to select pay lines across displayed symbol positions (e.g., symbol display areas) on reels in a game in which to place wagers. Although in some implementations, the gaming system selects the wagered pay lines automatically based on the player's wager. Wagered pay lines may be referred to herein as active pay lines. In one implementation, the gaming system may determine whether the player provided enough credits to enable the player's selected wager. The gaming system may prevent the player from placing the wager and starting a play of a game if the player's credit balance is not large enough to support the player's selected wager. If enough credits are not available in the player's credit balance, the gaming system enables the player to insert additional value to obtain the minimum credit level or to cash out of the gaming system.

In one implementation, the gaming system may use a processor of the gaming system to update a gaming credit balance. The credit balance may be updated in accordance with the player's wager amount as indicated in block 320. In some implementations, the credit balance is not updated until a later time.

Block 325 illustrates one implementation in which the gaming system may receive a request to initiate a play of a game. The request to initiate the play of the game may be received from a player via a player input device in communication with the gaming system. The gaming system may securely access game data from a memory device and execute an authentication routine on the game data to start a play of a game as discussed above. For example, the player may press a spin button on the gaming system to start spinning slot machine reels of the gaming system (or randomly generating symbols using other methods discussed above for virtual reels) for the play of the game. It should be appreciated that reels used throughout the specification may refer to mechanical reels, electro-mechanical reels, or virtual video reels (where virtual reels strips or no reel strips are used). It should further be appreciated that although many examples illustrated in the specification describe the games in terms of slot machines with reels, other games may be used, including games without slot machine reels.

In one implementation, the gaming system may use a random number generator to randomly generate a plurality of symbols from a plurality of symbol sets as indicated in block 330. In some implementations, the gaming system may generate the plurality of symbols for display on a set of reels (or virtual reels). In some such implementations, each reel is associated with its own set of symbols. As used herein, the random number generation may refer to pseudo-random or true-random number generation depending on the module used for the random number generation.

In one implementation, the gaming system may cause a display device to display the plurality of symbols generated as indicated in block 335. In a game using reels, the gaming system may display the generated plurality of symbols in visible symbol display areas of each of the reels. Off page connector A refers to FIG. 3B to continue operation 300.

Turning now to FIG. 3B and off page connector A, in one implementation as shown in block 340, the gaming system evaluates the generated plurality of symbols across active or wagered pay lines for winning symbol combinations. In some implementations, the gaming system evaluates the winning symbol combinations based on the pay lines wagered upon by a player. The gaming system may evaluate the player selected pay lines, gaming system assigned pay lines, or pay lines assigned as active in some other manner for the play of the game. In one implementation using reels, the gaming system determines an award amount based on winning symbol combinations formed across the reels on active pay lines. For example, if a pay table associated with the gaming system indicated that at least three of the same bar symbols is a winning symbol combination and awards a predetermined payout, the gaming system would evaluate the generated plurality of symbols for bar symbols. If the gaming system generated at least three bar symbols on adjacent reels and along an active pay line, the gaming system may determine that the three bar symbols is a winning symbol combination based on the predetermined pay table. It should be appreciated that a pay table may include any suitable number of winning symbol combinations and payouts. In one implementation, a pay table may indicate that as few as one symbol may be associated with a payout. Alternatively, two or more symbols may be used to form winning symbol combinations that result in a payout.

In block 345, the gaming system determines, with the processor, a payout amount based on the evaluated winning symbol combinations across wagered pay lines. As illustrated in block 350, the gaming system may update, with the processor, the player's gaming credit balance in accordance with any award amount. As noted above, the blocks illustrated in FIGS. 3A-3D can be rearranged in any suitable order. As such, it should be appreciated that the gaming system may update player's gaming credit balance at other suitable times.

In one implementation, as indicated in block 355, the gaming system evaluates the plurality of symbols across wagered pay lines for symbol combinations that trigger a bonus game with a predetermined quantity of spins (or activations, where the bonus game does not use slot reels). In some implementations the symbol or symbol combinations that trigger the bonus game do not need to appear on wagered pay lines. In some implementations, the predetermined quantity of spins are provided as free spins. In other implementations, the player may pay to obtain the predetermined quantity of spins. It should also be appreciated that in some implementations, events other than generating one or more of a predetermined symbol may trigger the bonus game. If the gaming system determined that the generated plurality of symbols did not result in triggering a bonus game, in block 360, operation 300 moves to block 362. In one implementation, as indicated in block 362, the gaming system may receive a signal to end game play or “cash out” via an input device of the gaming system. In such a situation, the gaming system dispenses a value to the player, through a value dispenser, based on the player's gaming credit balance as illustrated in block 364 and operation 300 ends.

On the other hand, if the gaming system processor has not received a signal to end game play via the player input device, the process of operation 300 returns to block 315 via off page connector B. The gaming system may receive, via a player input device, a wager for another play of the game and continue operation 300 from block 315. However, in one implementation, the wager may not be accepted if the player has fewer credits than the player's selected wager amount as shown in block 315.

Returning now to block 360, if the gaming system determined that the generated plurality of symbols resulted in trigging a bonus game, operation 300 moves to block 366 in FIG. 3C via off page connector C. In one implementation, if the gaming system determines that the generated plurality of symbols includes one or more generated predetermined symbols, the gaming system will trigger or activate the bonus game. In one implementation, the predetermined symbol is a symbol that serves one function: to trigger the bonus game. In alternative implementations, the predetermined symbol serves a plurality of game functions, such as triggering the bonus game and providing an award value. Other suitable game functions may be associated with the predetermined symbol.

The request to initiate the play of the bonus game may be received from a player via a player input device in communication with the gaming system. The gaming system may securely access game data from a memory device and execute an authentication routine on the game data to start a play of the bonus game as discussed above. For example, the player may press a spin button on the gaming system to start spinning slot machine reels of the gaming system (or randomly generating symbols using other methods discussed above for virtual reels) for the play of the bonus game. It should further be appreciated that although the examples illustrated in the specification describe the games in terms of slot machines with reels, other games may be used, including games without slot machine reels.

In some implementations, the gaming system alters the play of the game during the bonus game. In some implementations, the gaming system may change how symbols operate. In some implementations, the gaming system may use different pay tables in the bonus game to calculate winning symbol combinations. In some implementations, the gaming system may use the same pay tables in the base game and the bonus game to calculate winning symbol combinations. In some implementations, the bonus game can be a similar game to the base game. In some implementations, the bonus game is a video slot reel game with a plurality of slot reels.

Returning to block 366 of FIG. 3C, block 366 illustrates one implementation in which the gaming system may receive a request to initiate a play of the bonus game. It should be appreciated that each play of the bonus game corresponds to one of the awarded predetermined quantity of spins for the bonus game in one implementation. It should also be appreciated that each play of the bonus game may occur within a play of the game (e.g., the play of the game is a combination of the base game and the bonus game). As noted above, the features discussed in connection FIG. 3C and FIG. 3D may also be applied to primary games or games that are not bonus games. The request to initiate the play of the bonus game may be received from a player via a player input device in communication with the gaming system. For example, the player may press a spin button on the gaming system to start randomly generating symbols for the play of the bonus game. In an alternative implementation, the processor of the gaming system may automatically initiate the play of the bonus game and randomly generate symbols for the play of the game.

In one implementation, the gaming system uses a random number generator in conjunction with the processor to randomly generate a plurality of symbols from one or more bonus symbol sets for the bonus game as indicated in block 368 (for a spin of the bonus game). In some implementations, the bonus symbol sets comprise one or more symbols that are different from the symbols from the primary game's symbol sets. In some implementations, the bonus symbol sets comprise the same symbols from the primary game's symbol sets. For some implementations without a bonus game, the gaming system randomly generates the plurality of symbols from one or more second symbol sets. In some implementations without a bonus game, the gaming system randomly generates the plurality of symbols from the same set, but may activate features associated with particular symbols, such as features associated with the replicating symbols.

In some implementations, the gaming system designates at least one symbol in at least one of the bonus symbol sets as a replicating symbol for the bonus game. In some implementations, the gaming system designates at least one symbol in each of the bonus symbol sets as a replicating symbol during the bonus game. It should be appreciated that the gaming system may designate any number of symbols in the bonus symbol sets as replicating symbols. In some implementations, the replicating symbol is the same symbol as the predetermined symbol to trigger a bonus game. In other implementations, the replicating symbol is different from the predetermined symbol to trigger a bonus game. In some implementations, the replicating symbol is replicated during a play of the game, where the replicated replicating symbol is used in evaluating symbol combinations for winning symbol combinations. In some implementations, the replicating symbol is used in place of another generated and displayed symbol.

In some implementations, the replicating symbol is a wild symbol. In some implementations, a wild symbol, is a type of symbol that can mimic or substitute for almost any symbol that a gaming system uses. For example, if the gaming system generates a wild symbol alongside other symbols, the gaming system may evaluate the wild symbol like one of the other symbols generated along a wagered pay line for purposes of determining a winning symbol combination in one implementation. As a specific example, if the gaming system generates a wild symbol alongside two Cherry symbols along a wagered pay line, the gaming system may evaluate the wild symbol as a Cherry symbol for purposes of determining whether the wild symbol and the two cherry symbols form a winning symbol combination of three Cherry symbols.

In some implementations, the replicating symbol is a pay symbol. In some implementations, the replicating symbol is a blank symbol. It should be appreciated that any suitable symbol in the bonus symbol sets for the bonus game can be designated as a replicating symbol.

In one implementation, the gaming system may cause a display device to display the plurality of symbols generated as indicated in block 370. In a bonus game using reels, the gaming system may display the generated plurality of symbols in visible symbol display areas of each of the reels.

The gaming system determines, with the processor of the gaming system, whether the generated plurality of symbols included any replicating symbols as indicated in block 372. In one implementation, if the gaming system determines that the generated plurality of symbols do not include any replicating symbols, the gaming system moves to off-page connector D and returns to block 362 in FIG. 3C. In some implementations, the gaming system may repeat blocks 368-372 when the bonus game includes a plurality of spins or activations (not shown). In some such implementations, the gaming system may repeat blocks 368-372 until no bonus spins or activations remain.

In one implementation, as indicated in block 362, the gaming system may receive a signal to end game play or “cash out” via an input device of the gaming system. In such a situation, the gaming system dispenses a value to the player, through a value dispenser, based on the player's gaming credit balance as illustrated in block 364 and operation 300 ends. On the other hand, if the gaming system processor has not received a signal to end game play via the player input device, the process of operation 300 returns to block 315 via off page connector B. The gaming system may receive, via a player input device, a wager for another play of the game and continue operation 300 from block 315. However, in one implementation, the wager may not be accepted if the player has fewer credits than the player's selected wager amount as shown in block 315.

Returning to block 372, if the gaming system determines that the generated plurality of symbols includes at least one replicating symbol, the gaming system moves to block 374 in FIG. 3D via off-page connector E. For each generated replicating symbol, the gaming system may copy (i.e., replicate) the replicating symbol in the bonus game in some implementations.

At block 374, the gaming system determines with the processor, a distance between a predetermined point displayed in the bonus game and a replicating symbol in some implementations. In some implementations, the predetermined point is an anchor that is displayed throughout the bonus game. In some implementations, the predetermined point is an anchor that is displayed after the gaming system determines that a replicating symbol was generated. In some implementations, the gaming system includes a plurality of predetermined points. In implementations with a plurality of predetermined points, the gaming system may randomly determine which of the predetermined points to use to measure the distance. It should be appreciated that the predetermined point can be represented by any object (e.g., a wall anchor, a hook on the wall anchor, a hook, a nail, a post, a pole, etc.) that can be used for connecting to another object (e.g., a rope, chain, etc.).

In one implementation, as illustrated in block 376, the gaming system generates and displays a connector connecting the replicating symbol and the predetermined point. In some implementations, the connector can be a rope, chain, a wire, or any other suitable object for connecting a replicating symbol to the predetermined point. In some implementations, the gaming system generates a connecting point on the replicating symbol that is used to connect to the connector. The gaming system also determines a length of the connector based on the determined distance between the predetermined point and the replicating symbol in some implementations.

As illustrated in block 378, the gaming system determines with the processor, a path of motion for the replicating symbol in some implementations. In some implementations, the path has a start point and end point. In some implementations, the start point and the end point of the path are different points. In alternative implementations, the start point and the end point of the path are the same point. In some implementations, the gaming system determines the path of motion for the replicating symbol based on the predetermined point, the position of the replicating symbol, and the connector connecting the replicating symbol to the predetermined point. In some implementations where the predetermined point is fixed, the connector and replicating symbols will pivot around the fixed predetermined point, creating an arc path that is based on the length of the connector. In some implementations where the predetermined point is fixed, the arc path is a full circular path. In some implementations with the full circular path, when the replicating symbol is moving around the circular path, the gaming system may spin the replicating symbol very fast and generate a wheel divided into slices. The wheel slices are each associated with an award. The gaming system may randomly determine one of the wheel slices to award to the player as part of the bonus game.

In some implementations, the predetermined point is movable across the display of the gaming system. In some such implementations, the motion of the predetermined point is linear and substantially horizontal, such that the path of the replicating symbol is linear and substantially horizontal. In some implementations, the connector can be (e.g., a chain) reeled in or wrapped around the predetermined point to move the replicating symbol in a vertical direction. The gaming system can use other suitable variations to determine the path. It should be appreciated that the path for the replicating symbol can also use some suitable combination of the above to determine the path for the replicating symbol.

In some implementations, physical properties of objects in the bonus game are not used to determine the path of the replicating symbol. For example, the physical properties of the generated connector are not used to determine the path in some implementations. In some example implementations, whether the connector is a chain with no elastic properties or a rope that typically has elastic properties, the gaming system may ignore these physical attributes when determining the path. On the other hand, in some implementations, physical properties can be associated with certain objects in the bonus game to determine the path. For example, if the gaming system used a rope as the connector, the elasticity of the rope may cause the gaming system to determine a path that is different from a path if the connector was a chain with less elasticity. In some implementations, the connector and the length of the connector is not used to determine the path. In some implementations, the path for the replicating symbol is predetermined. In some implementations, the path for the replicating symbol is randomly determined from a set of predetermined paths.

As illustrated in block 380, in some implementations, the gaming system randomly generates, using the processor in conjunction with the random number generator, at least one stop position for the replicating symbol along the determined path. In some implementations, a stop position corresponds to one of the symbol display areas. In some implementations, the gaming system may use the at least one stop position along the determined path as a position to place the replicating symbol or a copy of the replicating symbol (e.g., where the replicating symbol is replicated). In some implementations, the at least one stop position is determined before the replicating symbol is moved along the path as illustrated in block 382. In other implementations, the at least one stop position is determined while the replicating symbol is moved along the path (not illustrated). In some implementations, the gaming system generates a plurality of stop positions for the replicating symbol. In some implementations with a plurality of stop positions, the gaming system places the replicating symbol or a copy of the replicating symbol at each of the plurality of stop positions. In alternative implementations with a plurality of stop positions, the gaming system randomly determines one or more of the plurality of stop positions to place the replicating symbol or a copy of the replicating symbol.

In one implementation, as illustrated in block 382, the gaming system moves the replicating symbol on the display along the determined path and generates a copy of the replicating symbol at the at least one stop position. In one such implementation, the gaming system removes the replicating symbol from its current position on the display and moves the replicating symbol along the determined path and eventually generates the copy of the replicating symbol at the at least one stop position. In some implementations, the connector is connected to the replicating symbol and therefore moves with the replicating symbol. In some implementations, gaming system moves the replicating symbol from the start point of the path to the end point of the path at least once, then moves the replicating symbol in reverse (from the end point of the path to the start point of the path). In some implementations, the gaming system reverses the movement of the replicating symbol at any suitable point along the path. In some implementations, the gaming system moves the replicating symbol from the start point of the path to the end point of the path a plurality of times. In some implementations, after a predetermined period of time and while the replicating symbol is moving along the path, the gaming system makes a copy of the replicating symbol and places the copy of the replicating symbol at the at least one stop position. In some implementations, the at least one stop position is a symbol display area that includes a symbol from the generated plurality of symbols for the bonus game. In some implementations, the copy of the replicating symbol covers the symbol from the generated plurality symbols that is in the same symbol display area. In some implementations, the copy of the replicating symbol replaces the symbol from the generated plurality of symbols that is in the same symbol display area (e.g., the at least one stop position). In some implementations, once the copy of the replicating symbol is placed in the stop position, the gaming system returns the replicating symbol to its originally displayed position.

In one implementation, rather than removing the replicating symbol from its current position in the display, the gaming system keeps the replicating symbol in its current position in the display and makes a copy the replicating symbol (e.g., replicates the replicating symbol). In such an implementation, the gaming system moves the copy of the replicating symbol along the path as noted above. In some implementations, after a predetermined period of time, while the copy of the replicating symbol is moving along the path, the gaming system places the copy of the replicating symbol at the at least one stop position. In some implementations, the at least one stop position is a symbol display area that includes a symbol from the generated plurality of symbols for the bonus game. In some implementations, the copy of the replicating symbol covers the symbol from the generated plurality symbols that is in the same symbol display area. In some implementations, the copy of the replicating symbol replaces the symbol from the generated plurality of symbols that is in the same symbol display area.

In one implementation, illustrated in block 384, the gaming system determines an award amount for the bonus game based on certain of the generated plurality symbols and the copy of the replicating symbol. The determination includes, in some implementations, an evaluation of certain ones of the generated plurality symbols and the copy of the replicating symbol for winning symbol combinations. In one implementation, the determination of the award amount does not include an evaluation of the symbol of the generated plurality of symbols that is in the same symbol display area as the copy of the replicating symbol. In another implementation, the determination of the award amount may include an evaluation of all the generated plurality of symbols and a second evaluation of certain of the generated plurality of symbols and the copy of the replicating symbol, where the second evaluation ignores the symbol of the generated plurality of symbols that is in the same symbol display area as the copy of the replicating symbol.

In block 386, the gaming system determines if any replicating symbols from the generated plurality of symbols remain unreplicated in one implementation. In other words, in some implementations, the gaming system may generate a plurality of replicating symbols. In one such implementation, the gaming system excludes any copy of a replicating symbol in such a determination. Thus, in some implementations, the gaming system does not perform blocks 374-386 for any copy of a replicating symbol. In alternative implementations, the gaming system performs blocks 374-386 for any displayed replicating symbol (including any copies of replicating symbols). If the gaming system determines that a replicating symbol from the generated plurality symbols remains unreplicated as illustrated in block 386, the gaming system returns to block 374 for the unreplicated replicating symbol. In some implementations where the gaming system generated a plurality of replicating symbols, gaming system may perform blocks 374-386 on more than one of the replicating symbols in parallel.

On the other hand, if the gaming system determines that no replicating symbols remain unreplicated, the gaming system moves to block 388. In block 388, the gaming system, using the processor, updates the player's gaming credit balance in accordance with any award amount for the bonus game and may proceed to off page connector D and return to block 362 in FIG. 3B.

As indicated in block 362, the gaming system may receive a signal to end game play or “cash out” via an input device of the gaming system. In such a situation, as illustrated in block 364, the gaming system dispenses a value to the player through a value dispenser based on the player's gaming credit balance and operation 300 ends.

On the other hand, if the gaming system processor has not received a signal to end game play via the player input device, the process of operation 300 returns to block 315 via off page connector B. The gaming system may receive, via a player input device, a wager for another play of the game and continue operation 300 from block 315. However, in one implementation, the wager may not be accepted if the player has fewer credits than the player's selected wager amount as shown in block 315.

In some implementations, the originally displayed position of a replicating symbol may determine a direction that the replicating symbol will move along the determined path. For example, if a replicating symbol was generated on a left-hand side of the display of the gaming system, the gaming system may move the replicating symbol (or a copy of the replicating symbol) from left to right along the determined path. As an alternative example, if a replicating symbol was generated on a right-hand side of the display of the gaming system, the gaming system may move the replicating symbol (or copy of the replicating symbol) from right to left along the determined path. In some implementations, the gaming system randomly determines which direction along the path replicating symbol may initially move

In one implementation, where the plurality of symbols generated for the bonus game are displayed on video slot machine reels, when a replicating symbol is displayed on one of the reels, the gaming system determines a path that extends across all of the plurality of reels.

In one implementation, if the gaming system places a copy of the replicating symbol at a stop position that already includes a replicating symbol, gaming system evaluates the copy of the replicating symbol as a multiplier for any determined awards.

In some implementations, a plurality of gaming systems can be linked together, form a path across the plurality of gaming systems, and display the replicating symbol moving across the plurality of gaming system to alter an outcome of a game on one or more of the gaming systems. For example, if one of the plurality gaming systems generates a replicating symbol, one or more of the gaming systems may determine a path for the replicating symbol that moves across two or more of the plurality of linked gaming systems. Thus, in some such implementations, the replicating symbol generated on one of the plurality of linked gaming systems may create a benefit for a different one of the plurality of linked gaming systems.

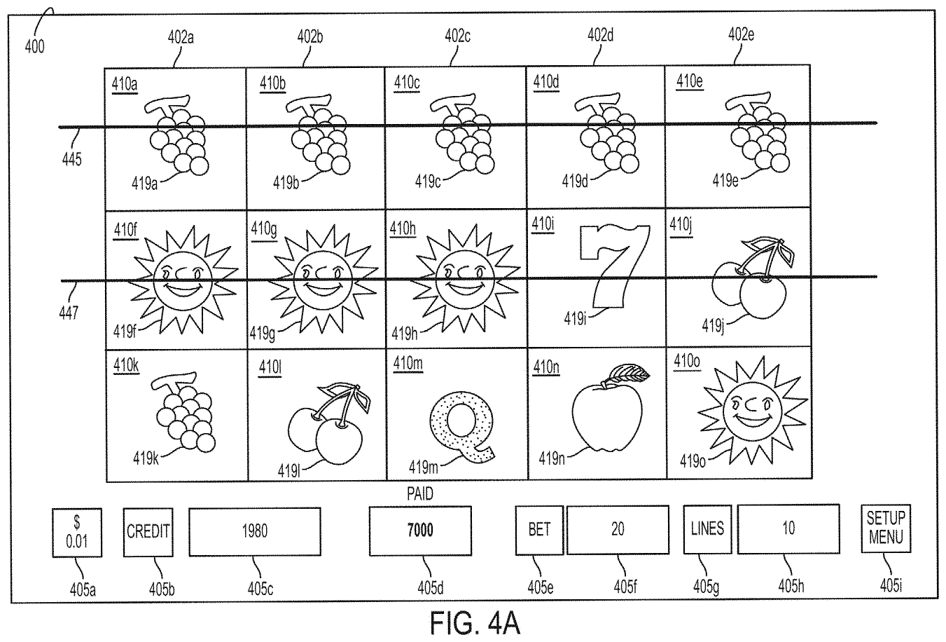

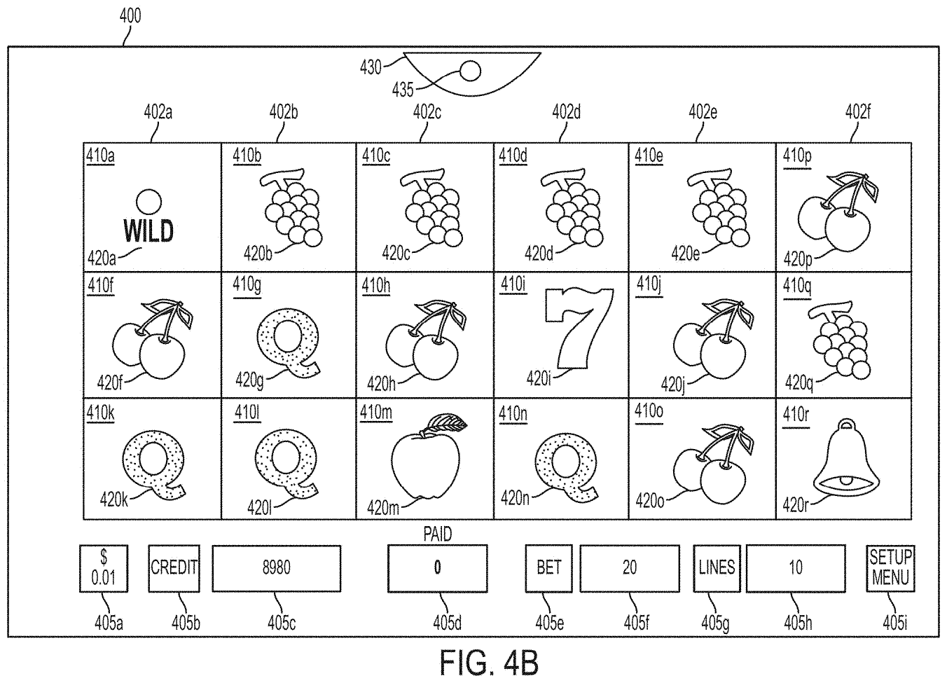

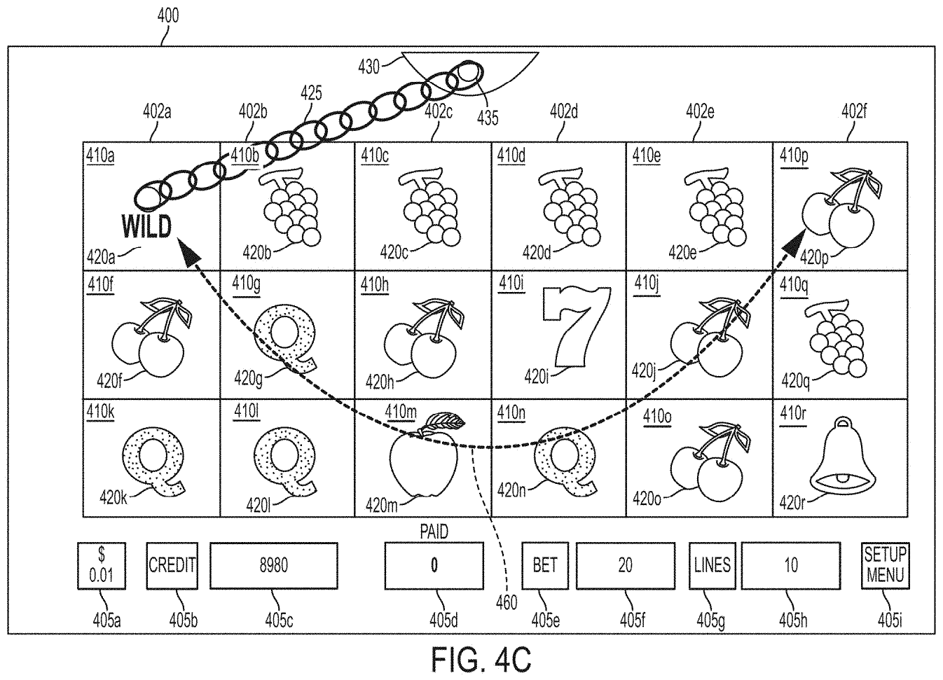

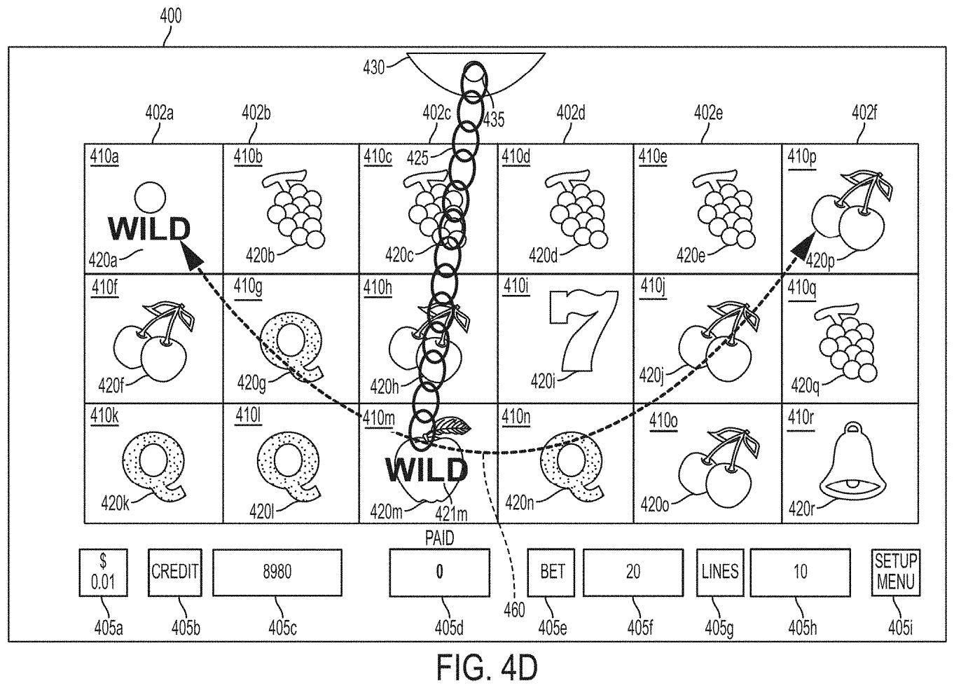

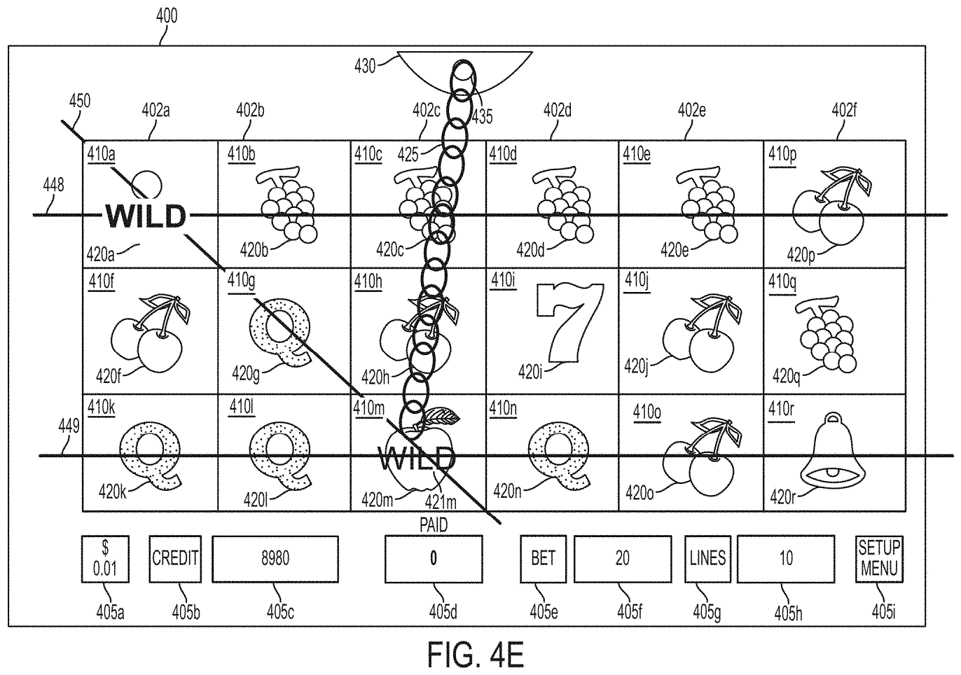

FIGS. 4A-4F illustrate screen shots of one implementation of a gaming system having replicating symbols for enhancing awards.

FIG. 4A illustrates one implementation of a game display 400 that the gaming system 1000 may display on a display device of the gaming system. In one implementation, game display 400 may be displayed on first display 122 of gaming system 1000 illustrated in FIG. 1. However, any other suitable display may be used. The game display 400 displays a set of a plurality of virtual video slot machine reels 402a, 402b, 402c, 402d, and 402e as illustrated in FIG. 4A for a primary or base game. As also illustrated in FIG. 4A, the reels 402a-402e are displayed substantially side by side. It should be appreciated that reels 402a-402e can be displayed with any suitable amount of separation or no separation. It should be appreciated that the game shown in game display 400 is merely representative and may have more or fewer game elements (e.g., reels, symbol display areas, symbols, etc.) shown in the game display 400. It should also be appreciated that other games may be used for the primary or base game.

The plurality of reels 402a-402e are each associated with a set of symbols, where each set of symbols includes a plurality of symbols. Each set of symbols can be associated with the same or a different plurality of symbols. The sets of symbols may include numbers, letters, geometric figures, symbols, images, character, blank symbols (e.g., the absence of symbols), animations, transparent symbols (e.g., symbols that permits underlying symbols to be visible), or any other suitable graphical depiction. The symbols in the sets of symbols may include pay symbols and special or designated symbols. In one implementation, at least one predetermined symbol is a triggering symbol for a bonus game. In one implementation, at least one triggering symbol must be generated on the reels during a play of a game to trigger the bonus game. In some implementations, a plurality of triggering symbols must be generated on the reels during a play of a game to trigger the bonus game. In one implementation, any one of the symbols in the sets of symbols can be designated as the predetermined triggering symbol. The triggering symbol may be associated with one function (e.g., triggering a bonus game), but may alternatively be associated with a plurality of different game functions. The triggering symbol may be a scatter symbol in some implementations. In some implementations, generated triggering symbols are not required to trigger a bonus game.

Returning now to FIG. 4A, the game display 400 depicts a plurality of symbol display areas (also referred to herein as symbol display positions) 410a, 410b, 410c, 410d, 410e, 410f, 410g, 410h, 410i, 410j, 410k, 410l, 410m, 410n, and 410o. These plurality of symbol display areas can be associated in a manner that provides the appearance of game reels. It should also be appreciated that the symbol display areas may not be associated with game reels in some implementations. As illustrated in FIG. 4A, symbol display areas 410a, 410b, 410c, 410d, 410e, 410f, 410g, 410h, 410i, 410j, 410k, 410l, 410m, 410n, 410o are associated in a manner that provides the appearance of a set of five slot machine game reels. In one implementation, the plurality of symbol display areas that provide the appearance of five game reels may be arranged in a manner that visibly shows three symbol positions of each of the five game reels. For example, the symbol display areas 410a-401o are each associated with positions on reels 402a-402e, respectively. As shown in FIG. 4A, symbol display areas 410a, 410f, and 410k are associated with reel 402a; symbol display areas 410b, 410g, and 410l are associated with reel 402b; symbol display areas 410c, 410h, and 410m are associated with reel 402c; and symbol display areas 410d, 410i, and 410n are associated with reel 402d; and symbol display areas 410e, 410j, and 410o are associated with reel 402e. The arrangement illustrated in the implementation of FIG. 4A thus creates a visible display area of the reels 402a-402e comprising three visible symbol positions for each reel. When viewed together, reels 402a-402e appear like a 3-row by 5-column reel array in display 400. In other implementations, smaller or larger visible areas of the reels can be displayed. That is, the reels 402a-402e may show fewer or a larger number of visible symbol display areas. In some implementations, gaming system may include more reels or fewer reels. While symbol display areas are illustrated with defined boxes, it should be appreciated that in some implementations, the defined boxes are not visible to the player. It should also be appreciated that in some implementations, the symbol display areas are other shapes or not defined shapes and may not be associated with reels.

Each reel 402a-402e may display a plurality of symbols that the gaming system generates from the sets of symbols in their respective symbol display areas as illustrated in FIG. 4A. In one implementation, the reels may be shown spinning in one direction to simulate slot machine reels. However, it should be appreciated that the reels may be shown spinning in any suitable direction. The reels may also be shown spinning in different directions in some implementations.

Game display 400 also includes several information areas and buttons 405a-405i. These information areas and buttons 405a-405i are illustrated in a particular arrangement, but may be arranged in any suitable manner in different implementations. In some implementations, game display 400 may include more or fewer display areas and buttons 405a-405i than illustrated. Information area 405a illustrates an example value of one credit for the game displayed in game display 400. Information areas 405b and 405c illustrate an example of the amount of the player's available credits. Information area 405d illustrates the amount of credits a player has won. Because FIG. 4A illustrates the start of a play of a game, the information area 405d shows zero credits have been won. Button 405e illustrates a software button that the player can select to place a bet or wager. It should be appreciated that the functionality of button 405e may also be replicated or replaced with a hardware button on the gaming system 1000. Information area 405f illustrates that the player has selected to wager 200 credits, wagering 20 credits for each of 10 pay lines. Button 405g illustrates a software button that the player can select to determine how many pay lines to wager on. It should be appreciated that the functionality of button 405g may also be replicated or replaced with a hardware button on the gaming system 1000. Information area 405h illustrates that the player selected to wager on 10 pay lines. Button 405i illustrates a software button that the player can select to obtain information about the game, change certain aspects of the game, obtain help, place an order, etc.

To start a gaming session, a player provides the gaming system with a deposit of value, using one of the suitable mechanisms discussed above. The gaming system receives and validates the player's deposit of value. The gaming system can then issue credits (or gaming credits) to the player based on the received value. The credits enable the player to initiate a play of a game and to also place wagers on a play of the game. The gaming system may provide a visual indication of the player's credit balance to the player as discussed above in information area 405c.

To initiate a play of a game, the player activates or presses one or more appropriate buttons on the gaming system to deduct credits necessary to play the game and to identify the player's wager. Along with receiving the player's wager, the gaming system may receive pay line selections or other game functions the player wishes to activate in exchange for the wager. The player may also actuate a game start button, a spin button, or a lever. The gaming system may deduct the appropriate credits from the player's credit balance after the wager or at any suitable time.

Upon receipt of the player's wager and activation of the game start button, the gaming system may show a display of spinning reels (not shown) for each of the reels 402a-402e. The spinning may appear to occur in a vertical top to bottom direction or in a vertical bottom to top direction (not shown), or in a combination of vertical directions (not shown). In one implementation, the gaming system randomly generates symbols from the associated sets of symbols for reels 402a.402e, respectively. As noted above, the gaming system may rely on random generation performed by a pseudo RNG, a true RNG, or hardware RNG specifically designed for gaming systems. In one implementation, the gaming system may also update the player's credit meter (information area 405c) to reflect the player's available credit balance. As shown in FIG. 4A, the player's credit meter (information area 405c) was decremented by 200 credits from 2180 to 1980 to reflect the 200 credit wager the player placed for the play of the game.

The gaming system displays the generated symbols 419a-419o in symbol display areas 410a-410o as illustrated in FIG. 4A. Symbols 419a-419o displayed on reels 402a-402e illustrate the randomly generated symbols from the set of symbols after the reels have stopped spinning. As illustrated in FIG. 4A, the gaming system randomly generated and displayed symbols 419a, 419f, and 419k in symbol display areas 410a, 410f, and 410k for reel 402a. The gaming system also randomly generated and displayed symbols 419b, 419g, and 419l in symbol display areas 410b, 410g, and 410l for reel 402b; symbols 419c, 419h, and 419m in symbol display areas 410c, 410h, and 410m for reel 402c; symbols 419d, 419i, and 419n in symbol display area 410d, 410i, and 410n for reel 402d; symbols 419e, 419j, and 419o in symbol display area 410e, 410j, and 410o for reel 402e.

As illustrated in FIG. 4A, the gaming system generated and displayed Grape symbols (419a, 419b, 419c, 419d, 419e, 419k), Sun symbols (419f, 419g, 419h, 419o), a Seven symbol (419i), Cherry symbols (419j, 419l), a Queen symbol (419m), and an Apple symbol (419n) in the game display 400. It should be appreciated that the displayed symbol combinations are merely for explanatory purposes and the gaming system may randomly generate any suitable combination of symbols based on defined symbol sets associated with the reels 402a-402e.

FIG. 4A further illustrates one implementation of a gaming system executing an evaluation of the generated symbols on reels 402a-402e for winning symbol combinations. As noted above, the player may have wagered on one or more pay lines (such as 10 pay lines shown in information area 405h). In one implementation, at least the active (wagered on pay lines) are evaluated for winning symbol combinations. Any suitable number of pay lines may be used to evaluate winning symbol combinations.

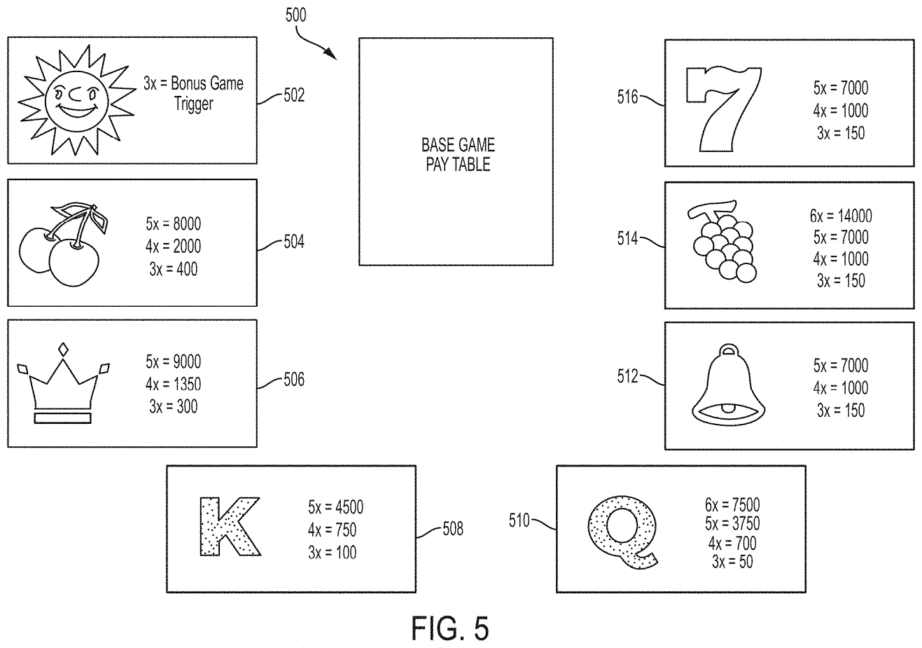

In the implementation illustrated in FIG. 4A, the gaming system evaluated the generated symbol combinations for winning symbol combinations. In FIG. 4A, the gaming system determined that a winning symbol combination is displayed across one wagered pay line. The pay line spans across a horizontal direction of symbol display areas including symbol display areas 410a, 410b, 410c, 410d, and 410e. In this implementation, the gaming system displayed five Grape symbols along a horizontal pay line on which the player had placed a wager. The gaming system determined the five Grape symbols form a winning symbol combination based on a pay table associated with the gaming system (such as the base game pay table in FIG. 5). The winning pay line is illustrated as pay line 445 in FIG. 4A across the row of reels 402a-402e. The gaming system may update information area 405d based on the award associated with the winning symbol combination to reflect 7000 credits.

As noted at block 355 of FIG. 3B, in one implementation, the gaming system may also evaluate the generated symbols on reels 402a-402e for triggering symbols that trigger a bonus game. As illustrated in FIG. 5, a bonus game is triggered when at least three Sun symbols are generated along a pay line. The three Sun symbols also provide a predetermined quantity of free spins for the bonus game in some implementations. In some implementations, the gaming system provides spins for the bonus game in exchange for some value from the player. For example, the player may be required to wager at a certain predetermined level or play the game over a certain period of time. In some implementations, the gaming system may require the player to wager a predetermined amount to obtain the predetermined quantity of spins for the bonus game. It should be appreciated that the predetermined quantity of spins can be three or any other suitable number.

Returning to FIG. 4A, the gaming system determined that three Sun symbols (419f, 419g, and 419h) were generated for the play of the game along wagered pay line 447. In the illustrated implementation, the Sun symbol was designated as the bonus game triggering symbol. It should be appreciated that any other suitable symbol could be designed as the bonus game triggering symbol. In some implementations, more than one different symbol can be designated as a bonus triggering symbol. In some implementations, a combination of different triggering symbols along a pay line may be required to trigger a bonus game. In some implementations, a predetermined quantity of scatter symbols can be used as a bonus game trigger. In some implementations, the scatter symbols do not need to appear on a wagered pay line to trigger the bonus game. In some implementations, the Sun symbols may be scatter symbols that trigger a bonus game. In some implementations, the gaming system may highlight the Sun symbols in some manner (not shown) so that player understands that the player won a bonus game or other game aspects. It should be appreciated that the gaming system may highlight the bonus triggering symbol in any suitable manner. It should also be appreciated that the gaming system may not highlight the bonus triggering symbols in some implementations, as is illustrated in FIG. 4A.

In some implementations, the gaming system may be required to generate more than one bonus triggering symbol to activate a bonus game (as shown in pay table of FIG. 5). In other implementations, the features available in the bonus game may depend on the quantity of bonus triggering symbols that the gaming system generates. In one implementation, at least one bonus trigging symbol must be generated in the far most reel 402a (in any symbol display area) to trigger the bonus game. That is, if the at least one bonus triggering symbol is generated in reels 402b, 402c, 402d, or 402e, (but not in reel 402a) the gaming system may not activate the bonus game. However, in other implementations, the bonus triggering symbol may appear on any reel in any symbol display area to trigger the bonus game. In some implementations, the gaming system may evaluate the bonus triggering symbols from a left to right direction along the reels. In some implementations, the gaming system may evaluate the bonus triggering symbols from a right to left direction along the reels.

Returning to FIG. 4A, the gaming system determined that three triggering symbols (the Sun symbols 419f, 419g, and 419h) were generated on reels 402a, 402b, and 402c in symbol display areas 410f, 410g, and 410h. Based on the generated bonus triggering symbol on such reels along wagered pay line 447, the gaming system activates a bonus game. In the illustrated bonus game, the gaming system award one spin for the bonus game.

In one implementation, the gaming system uses the same symbol sets associated with the same reels for both the primary game and the bonus game, but changes some aspect for the bonus game. In other implementations, gaming system uses different symbol sets associated with the reels for the bonus game. In some implementations, as is discussed below, the gaming system selects at least one of the symbols in one of the symbol sets as a replicating symbol. As will be illustrated in FIG. 4B-FIG. 4F, the gaming system selected a wild symbol to be a replicating symbol. In some implementations, the gaming system may select a pay symbol to be a replicating symbol. In other implementations, the gaming system may select a pay symbol and a wild symbol to be replicating symbols. In still other implementations, the gaming system may select a plurality of pay symbols and a plurality of wild symbols are replicating symbols.

FIG. 4B illustrates one implementation where the player won a bonus game with a free spin. In this illustrated implementation, the bonus game includes one extra reel 420f over the five reels of the base game. In one implementation, the gaming system may automatically start the bonus game and execute the free spin (to generate a new plurality of symbols for display on the reels), where a free spin is a play of the bonus game (which occurs within a play of the game). In one implementation with a plurality of free spins, the gaming system may automatically continue executing the available free spins until no free spins remain. In one alternative implementation, the gaming system may enable the player to manually start one or more free spins in the bonus game. FIG. 4B further illustrates each of reels 402a-402f displaying a generation of symbols on the reels for the play of the bonus game. FIG. 4B also illustrates predetermined point 435 on anchor 430.

As illustrated in FIG. 4B, the gaming system randomly generated symbols 420a-420r from the sets of symbols associated with reels 402a-402f, respectively. As noted above, the gaming system may rely on random symbol generation performed by a pseudo RNG, a true RNG, or hardware RNG to generate the symbols for the bonus game.

The gaming system displays the generated symbols 420a-420r in symbol display areas 410a-410r as illustrated in FIG. 4B. Symbols 420a-420r displayed on reels 402a-402f illustrate the randomly generated symbols after the reels have stopped spinning. As illustrated in FIG. 4B, the gaming system randomly generated and displayed symbols 420a, 420f, and 420k in symbol display areas 410a, 410f, and 410k for reel 402a. The gaming system also randomly generated and displayed symbols 420b, 420g, and 420l in symbol display areas 410b, 410g, and 410l for reel 402b; symbols 420c, 420h, and 420m in symbol display areas 410c, 410h, and 410m for reel 402c; symbols 420d, 420i, and 420n in symbol display area 410d, 410i, and 410n for reel 402d; symbols 420e, 420j, and 420o in symbol display area 410e, 410j, and 410o for reel 402e; and symbols 420p, 420q, and 420r in symbol display area 410p, 410q, and 410r for reel 402f.

As illustrated in FIG. 4B, the gaming system generated and displayed a Wild symbol (410a), Grape symbols (420b, 420c, 420d, 420e, 420k, 420q), Cherry symbols (420f, 420h, 420j, 420o, 420p), a Seven symbol (420i), Queen symbols (420g, 420k, 420l, 420n), an Apple symbol (420m), and a Bell symbol (420r) in the game display 400. It should be appreciated that the displayed symbol combinations are merely for explanatory purposes and the gaming system may randomly generate any suitable combination of symbols based on defined symbol sets associated with the reels 402a-402f. As also illustrated in FIG. 4B, the Wild symbol 420a includes a connection point to receive a connector.

FIG. 4C illustrates the gaming system determining that the gaming system generated a replicating symbol (Wild symbol 420a) for the bonus game. In FIG. 4C, the gaming system determines a distance between Wild symbol 420a and predetermined point 435 of anchor 430. Based on the determined distance, the gaming system generates and displays chain 425 in accordance with the determined distance. FIG. 4C further displays chain 425 connected to the predetermined point 435 and connected to the connection point of Wild symbol 420a.

The gaming system also determines a motion path for Wild symbol 420a. In the implementation illustrated in FIG. 4C, the gaming system determines the motion path based on the fixed predetermined point 435, the length of chain 425, and the position of Wild symbol 420a in symbol display area 410a. As a wild symbol 420a swings with chain 425 about the predetermined point 435, it should be appreciated that wild symbol 420a will move in an arc-shaped path 460. The arc shaped path 460 allows Wild symbol 420a to move through symbol display areas 410g, 410m, 410n, 410j, and 410p. In one implementation, the gaming system also randomly generates at least one stop position for the Wild symbol 420a. In the illustrated implementation, the at least one stop positions corresponds to one of the symbol display areas in the determined path. As noted above, the gaming system may randomly generate a plurality of stop positions for the Wild symbol 420a. In some implementations, each of the plurality of stop positions corresponds to a different one of the symbols display areas. In the implementation illustrated in FIG. 4A-4F, the Wild symbols are replicated (or copied), and the copied version of the Wild symbols are moved along the motion path. As noted above, in some implementations, the Wild symbols are not replicated until they are placed in a stop position. In some implementations, the stop positions may not correspond with only one symbol display area. That is, in some implementations, the stop positions may cause a replicating symbol to overlap two or more symbol display areas. In such implementations, when the gaming system evaluates the displayed symbols and the replicating symbol, the replicating symbol may be used for each symbol display area that the replicating symbol overlaps or touches.

Turning now to FIG. 4D, the gaming system moves a copy of Wild symbol 420a (which is Wild symbol 421m) along motion path 460 which is in part dictated by the length of chain 425 and the fixed predetermined point 435. In this implementation, because Wild symbol 420a was generated on the left hand side of reels, the gaming system will move Wild symbol 420a (or its copy, Wild symbol 421m) from left to right along the motion path. On the other hand, if Wild symbol 420a had been generated on the right hand side, such as on reel 402f, the gaming system may move Wild symbol 420a (or its copy) from right to left.

As noted in connection with FIG. 3A-3D, the gaming system may move Wild symbol 421m along the path 460 one or more times. After a predetermined period of time, the gaming system places or drops Wild symbol 421m in the randomly determined stop position. As illustrated in FIG. 4D, the randomly determined stop position corresponds with symbol display area 410m. In some implementations, where a plurality of stop positions were generated, the gaming system may place Wild symbol 421m in a first stop position and then generate another copy of Wild symbol 420a for each of the plurality of stop positions. In an alternative implementation, the gaming system may generate copies of Wild symbol 421m for each of the plurality of stop positions.

As is illustrated in FIG. 4D, the gaming system placed Wild symbol 421m over Apple symbol 420m. In some implementations, the replicating symbol will be layered over an existing symbol in a stop position without replacing the existing symbol. In other implementations, the gaming system removes any symbol in a symbol display area that is also occupied by a replicating symbol. That is, in one implementation, when the gaming system places the Wild symbol 421m in symbol display area 410m, the gaming system also removes the Apple symbol 420m.

In the implementation illustrated in FIG. 4E, the gaming system evaluated the generated symbol combinations for winning symbol combinations. In FIG. 4E, the gaming system determined that three separate winning symbol combinations were displayed across three pay lines. The three pay lines span across a horizontal direction of symbol display areas including symbol display areas 410a, 410b, 410c, 410d, and 410e; symbol display areas 410k, 410l, 410m, and 410n; and symbol display areas 410a, 410g, and 410m. In this implementation, the gaming system displayed four Grape symbols along a horizontal pay line on which the player had placed a wager. The gaming system also evaluated the Wild symbol 420a as another Grape symbol. The gaming system determined that five Grape symbols form a winning symbol combination based on a pay table associated with the gaming system (such as the pay table in FIG. 5). The first winning pay line is illustrated as pay line 448 in FIG. 4E across the row of reels 402a-402f. In this implementation, the gaming system also displayed three Queen symbols along another horizontal pay line on which the player had placed a wager. The gaming system further evaluated the Wild symbol 421m (replicated replicating symbol) as another Queen symbol. The gaming system determined that four Queen symbols form a winning symbol combination based on a pay table associated with the gaming system (such as the pay table in FIG. 5). The second winning pay line is illustrated as pay line 449 in FIG. 4E across the row of reels 402a-402d. In this implementation, the gaming system also displayed one Queen symbol along a horizontal pay line on which the player had placed a wager. The gaming system also evaluated the Wild symbol 420a and Wild symbol 421m as Queen symbols. The gaming system determined that three Queen symbols form a winning symbol combination based on a pay table associated with the gaming system (such as the pay table in FIG. 5). The third winning pay line is illustrated as pay line 450 in FIG. 4E across the row of reels 402a.402c. The gaming system may update information area 405d based on the award associated with the winning symbol combination to reflect 7450 credits. In this implementation, the gaming system ignored the Apple symbol 420m for purposes of evaluating the displayed symbols for winning symbol combinations.

In alternative implementations, the gaming system may perform an initial evaluation of the displayed symbols for winning symbol combinations using the Apple symbol 420m (or some symbol covered or replaced by a replicating symbol). In this alternative implementation, the gaming system may also perform another evaluation of the displayed symbols for winning symbol combinations while ignoring the Apple symbol 420m and using a replicated or copied replicating symbol in place of the Apple symbol 420m. In some such implementations, the gaming system may provide the player with any award associated with both evaluations (awards without the replicating symbol and awards with the replicating symbol), thus the replicating symbol can be used to increase the amount of symbols available for evaluating winning symbol combinations in some implementations.

In some implementations, the gaming system evaluates all symbols generated and displayed for this bonus game illustrated in FIG. 4E. However, in some implementations, the gaming system skips evaluating pay lines that do not include replicating symbols. By skipping evaluation of all of the generated and displayed symbols, the efficiency of the gaming system can be improved because less memory and less processing power is used during the gaming system's evaluation after each free spin. This efficiency also translates into faster game play because less time is used to complete the game's evaluation. When such efficiency improvements are made and applied to the hundreds and thousands of games evaluations that are made on a casino floor during a given period of time for the disclosed gaming system, the new gaming system will provide casino game operators sizable gains in machine efficiency.

In the illustrated implementation, no spins of the bonus game remains. Therefore, the gaming system does not generate additional symbols for symbol display areas in the bonus game and the play of the game and the bonus game ends. The player may continue to play additional games or cash out as discussed in connection with FIGS. 3A-3D. While the implementation illustrated in FIG. 4A-4F did not include multiple spins of the bonus game, in some implementations, the bonus game includes multiple spins and the bonus game may continue.

Turning now to FIG. 4F, the gaming system in one implementation provides the player with information regarding all of the awards for the play of the game. In this implementation, the gaming system alerts the player that the player won 7450 credits in the bonus game. In some implementations, the gaming system may break down how the player won the credits. For example, the gaming system may describe that the five Grape symbols along a wagered pay line pays 7000 credits (e.g., based on the pay table illustrated in FIG. 5). The gaming system may also describe that the four Queen symbols along a wagered pay line pays 400 credits (e.g., based on the pay table illustrated in FIG. 5). The gaming system may also describe that the three Queen symbols along a wagered pay line pays 50 credits (e.g., based on the pay table illustrated in FIG. 5). It should also be appreciated that the awards illustrated in FIG. 4F and FIG. 5 are merely illustrative and could be adjusted to include any suitable awards and different credit amounts.

As illustrated in FIG. 4F, the gaming system awards the appropriate number of credits to the player and updates the player's win meter (shown in information area 405d) to reflect the player's winnings during the play of the bonus game. In one implementation, the gaming system may also update the player's credit meter (information area 405c) to reflect the player's available credit balance based on awards from the base game and the bonus game.

If the player does not have additional spins of the bonus game, the player may continue the gaming session by playing another play of the game. That is, the player may place another wager and start a new play of the game, as noted above. However, continued game play is dependent of the number of credits remaining in the player's credit balance. The player may also choose to cash out. In such an instance, the gaming system provides the player a value based on the player's credit balance using any of the value items discussed above (bills, coins, vouchers, etc.).

FIG. 5 illustrates a screen shot of one implementation of a pay table 500 for a base game of the gaming system. Tables 502, 504, 506, 508, 510, 512, 514, and 516 are merely example payout awards for example symbol combinations. As noted above, it should be appreciated that the pay table is merely illustrative, and the symbols, awards, and the credit values may all be modified in any suitable manner

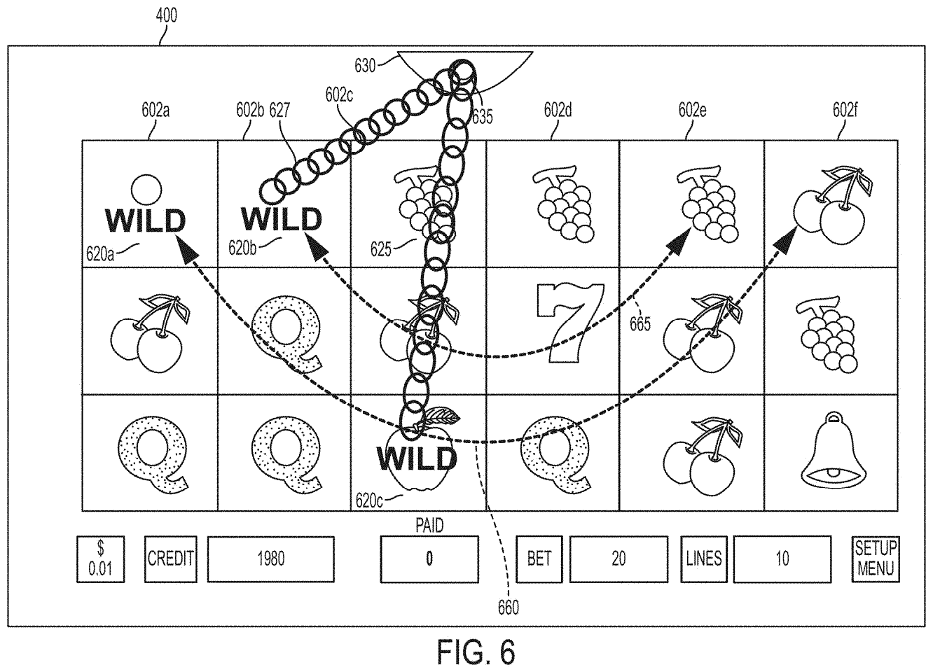

FIG. 6 illustrates a screen shot of one implementation of a gaming system having replicating symbols for enhancing awards. The game depicted in FIG. 6 is similar to the game described in FIG. 4A-4F and similar elements will not all be described again for the sake of brevity. Like in FIG. 4A-4F, the game display 600 displays a set of a plurality of virtual video slot machine reels 602a, 602b, 602c, 602d, 602e, and 602f as illustrated in FIG. 6 for a primary or base game. It should be appreciated that the game shown in game display 600 is merely representative and may have more or fewer game elements (e.g., reels, symbol display areas, symbols, etc.) than shown in the game display 600. It should also be appreciated that other games may be used for the primary or base game.

Unlike FIG. 4A-4F, the gaming system generated two replicating symbols, Wild symbol 420a and Wild symbol 420b, during a play of a bonus game. As a result, gaming system performed the features described in FIG. 3D for each of Wild symbol 420a and Wild symbol 420b (i.e., replicating symbols). In some implementations, the features described in FIG. 3D are applied to each replicating symbol in series (the gaming system does not act upon one replicating symbol until a currently executing replicating process of FIG. 3D is complete for another replicating symbol). However, as noted in FIG. 3A-3D, the process 300 can be executed in different suitable orders. In the implementation illustrated in FIG. 6, the gaming system generated a chain 625 connecting a copy of Wild symbol 620a (e.g., Wild symbol 620c) to the predetermined point 635 on anchor 630. In the implementation illustrated in FIG. 6, the gaming system also generated a chain 627 connecting a copy of Wild symbol 620b (not visible) to the predetermined point 635 on anchor 630. The gaming system also determined a motion path for each of the Wild symbol 620a and Wild symbol 620b. The motion paths are path 660 and path 665 and are determined in a manner similar to the manners discussed above. The gaming system can determine stop positions for the replicating symbols in a manner similar to the manners discussed above. In FIG. 6, the gaming system moves Wild symbol 620c (a copy of Wild symbol 620a) along its determined path 660 and will eventually place Wild symbol 620c in at least one determined stop position. FIG. 6 illustrates that Wild symbol 620b (or its copy) is not moved along its determined path 665 while the gaming system moves Wild symbol 620c along its determined path 660. In alternative implementations, the process described in FIG. 3D for replicating symbols may occur in parallel for each displayed replicating symbol. In some implementations, the gaming system may move Wild symbol 620c and a copy of Wild symbol 620b on their respective paths at approximately the same time. The gaming system may place Wild symbol 620c and a copy of Wild symbol 620b in their respective stop positions at substantially the same time or at different times. Evaluations for winning symbol combinations and award determinations can be performed after each Wild symbol 620a and Wild symbol 620b have been replicated in some implementations. In other implementations, the evaluations for winning symbol combinations and award determinations can be performed after all replicating symbols have been replicated.

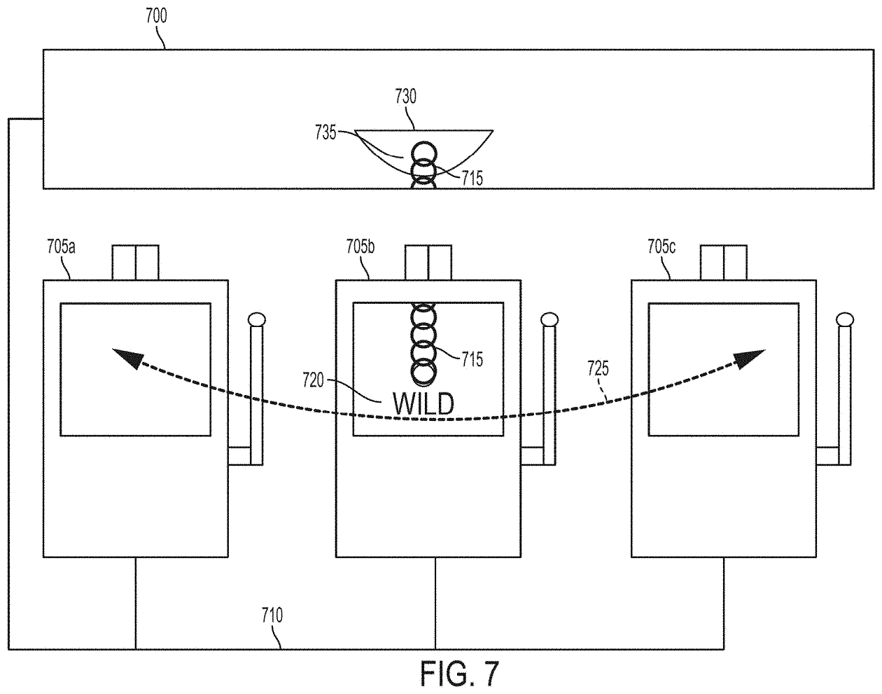

FIG. 7 illustrates a plurality of gaming systems that are in communication with each other over network 710. The plurality of gaming system can communicate to generate a unified game having replicating symbols. Gaming systems 705a, 705b, and 705c are a representation of a plurality of network gaming systems. There may be more or fewer gaming systems that are in communications with each other. The networked gaming systems may also be in communication with a separate display screen 700. The display screen 700 can communicate with the networked gaming systems 705a-705c to create a unified game using the replicating symbols. In some implementations, the separate display screen 700 may display the predetermined point 735 on anchor 730. In some implementations, if one of the plurality of gaming systems generates a replicating symbol, one or more of the gaming systems may determine a path for the replicating symbol that moves across two or more of the plurality of linked gaming systems. In the implementation illustrated in FIG. 7, gaming system 705b generated a replicating symbol (Wild symbol 720). The gaming system 705b determined a distance between the predetermined point 735 and the Wild symbol 720. The gaming system 705b generated a chain connector 715, whose length is based on the determined distance. In some implementations, the gaming system 705b also determines a path based on the predetermined point 735, the chain 715, and the position of the Wild symbol 720 as discussed above. In the illustrated implementation, the path 725 spans across a plurality of gaming systems 705a, 705b, and 705c. The path can span across more or fewer gaming systems. Gaming system 705b may determine one or more stop positions for the Wild symbol 720 along path 725. In one implementation, at least one stop position along path 725 is on gaming system 705b and at least one other stop position is on another one of the gaming systems. In some implementations, the stop position is always on a gaming system other than the gaming system that generated the replicating symbol. In some implementations, a stop position is determined for each gaming system that is in the path 725. While gaming system 705b is described as executing the process 300 of FIG. 3D for the game illustrated in FIG. 7, any suitable other machine or server may perform the process 300 of FIG. 3D. The process 300 may be handled by one of the other gaming systems 705a or 705c; the process 300 may be handled by a server in communication with the gaming systems 705a, 705b, 705c, and the display screen 700 over network 710.

In some implementations, the unified game having replicating symbols across a plurality of gaming system is not activated until a predetermined amount of wagers are placed at the plurality of gaming systems. In some implementations, the unified game having replicating symbols across a plurality of gaming system is activated regardless or independent of placed wagers. In some implementations, the unified game having replicating symbols across a plurality of gaming systems is not activated until one or more of the network gaming systems have been in use for a predetermined amount of time. It should be appreciated that any suitable criteria may be used to restrict when the network gaming systems may generate the unified game having replicating symbols.

FIGS. 8A, 8B, 8C, and 8D illustrate a flow block diagram for a method 800 of a gaming system (e.g., gaming system 100) in accordance with aspects of the present disclosure. FIGS. 8A and 8B depict a game provided by the gaming system, which may be a base game. FIGS. 8C and 8D depict a second feature or a replicating feature of the game. In some implementations, the second feature can be a replicating game or a bonus game triggered by a predetermined event in the base game, such as a display of a particular symbol, combination of symbols, or arrangement of symbols. In other implementations, the second feature can be provided concurrently or as part of the base game. It is understood that the operations shown in FIGS. 8C and 8D may be used with those of FIGS. 8A and 8B, without being initiated as a separate game based on a triggering event.

Blocks 805-825 of FIGS. 8A and 8B can be the same or similar to blocks 305-350 of FIG. 3A and 3B, previously detailed herein. At block 831 of FIG. 8B, the gaming system determines whether the replicating game has been triggered. In implementations, the trigger of the replicating game comprises the display of one or more predetermined replication trigger symbols among symbols determined at block 817. For example, the gaming system may trigger the replicating game when a trigger symbol is displayed in a predetermined location, sequence of locations, or combination of locations, such as along an active pay line. The trigger symbols can be the same or similar to the trigger symbols previously described herein. It is understood that some implementation trigger the replicating game based on other events. For example, in some implementations, the gaming system can randomly trigger the replicating game based on, for example, an output from a random number generator. In some implementations, the gaming system randomly triggers the replicating game after occurrence of a threshold number of events since trigging a since a previous triggering of the replicating game (e.g., after wager values in a gaming session exceed a threshold, after a quantity of plays of a game, after a predetermined period of time, etc.).

If the gaming system determines that the symbols determined at block 817 do not trigger the replicating game (e.g., block 831 is “No”), then the method 800 proceeds to block 833. At block 833, the gaming system determines whether a request to cash out has been received, in a same or similar manner to that previously described herein with respect to block 362 of FIG. 3B. For example, the gaming system may receive a signal from an input device (e.g., one of the input devices 115 in the player interaction area 112) to end game play or “cash out.” In such a situation, at block 835, the gaming system dispenses a value to the player, through a value dispenser (e.g., value dispenser 222) based on the player's gaming credit balance updated at blocks 811 and 825 in a same or similar manner to that previously described herein with respect to block 364 of FIG. 3B and the method 800 ends. On the other hand, if at block 833, the gaming system has not received a request to end game play (e.g., block 833 is “No”), then the method 800 returns to block 809 via off-page connector “D,” at which the gaming system may receive a wager for another play of the game and continue method 800 in a same or similar manner to that previously described herein with respect to block 362 of FIG. 3B. It is understood that the method 800 may not continue if the credit balance determined at block 825 is less than the selected wager amount as shown in block 809.

Referring back to block 831, if the gaming system determined that the replicating game has been triggered, then the method 800 proceeds to block 837 in FIG. 8C, as indicated by off-page connector “C.” At block 837, the gaming system initiates a play of the replicating game, in a same or similar manner to that previously described herein with respect to block 366 of FIG. 3C. As noted above, the operations discussed in connection FIGS. 8C and 8D may also be applied to a base game, which may include operations that are the same or similar to those illustrated in FIGS. 8A and 8B. In some implementations, the request to initiate the play of the replicating game may be received from a player via a player input device (e.g., one of input devices 115). For example, the player may press a spin button on the gaming system to start play of the replicating feature. In other implementations, the gaming system may automatically initiate the play of the replicating feature.

At block 839, the gaming system can randomly determine symbols for the symbol display areas from one or more sets of symbols in a same or similar manner to that previously described with regard to block 368 of FIG. 3C. The sets of symbols can be the same or different than those used at block 817. In accordance with aspects of the present disclosure, the sets of symbols used at block 839 can include replicating symbols. Additionally, in some implementations, the sets of symbols can include blocking symbols, as described below. It is understood that, in some implementations at block 839, the replicating game can reuse some or all of the symbols determined and displayed at blocks 817 and 819, instead of determining and displaying additional symbols at blocks 839 and 841. For example, at block 839, some implementations of the gaming system can randomly select one of the symbol display areas to display the replicating symbol and replace the symbol displayed in that symbol display area at block 819 with the replicating symbol, without replacing other of the symbols displayed at block 841. Additionally, some implementations of the gaming system may convert a trigger symbol identified at block 831 to a replicating symbol used in the replicating game. At block 841, the gaming system can display the symbols determined at block 839 in the symbol display areas in a same or similar manner to that previously described with regard to block 370 of FIG. 3C.

At block 843, the gaming system determines whether the symbols determined at block 839 for the symbol display areas include a replicating symbol in a same or similar manner to that previously described with regard to block 372 of FIG. 3C. If the symbol display areas do not include any replicating symbols (e.g., block 843 is “No”), then the method 800 can proceed to block 833, as indicated by off-page connector “B,” and continue as described above.

If the symbol display areas include a replicating symbol (e.g., block 843 is “Yes”), then the gaming system can display the replicating symbol moving through the symbol display areas, which may generate additional winning symbol combinations. In some implementations, the replicating symbol can move in one or more parabolic or arcuate paths in a same or similar manner to that previously described with regard to FIGS. 4A-4F. Additionally, in some implementations, the replicating symbol can move in one or more straight-line paths through the symbol display areas. In some implementations, the replicating symbol can move in one or more oscillating paths. For example, the replicating symbol can move through the symbol display areas in a path similar to a square wave, a sinusoidal wave, a triangular wave, or a sawtooth wave.

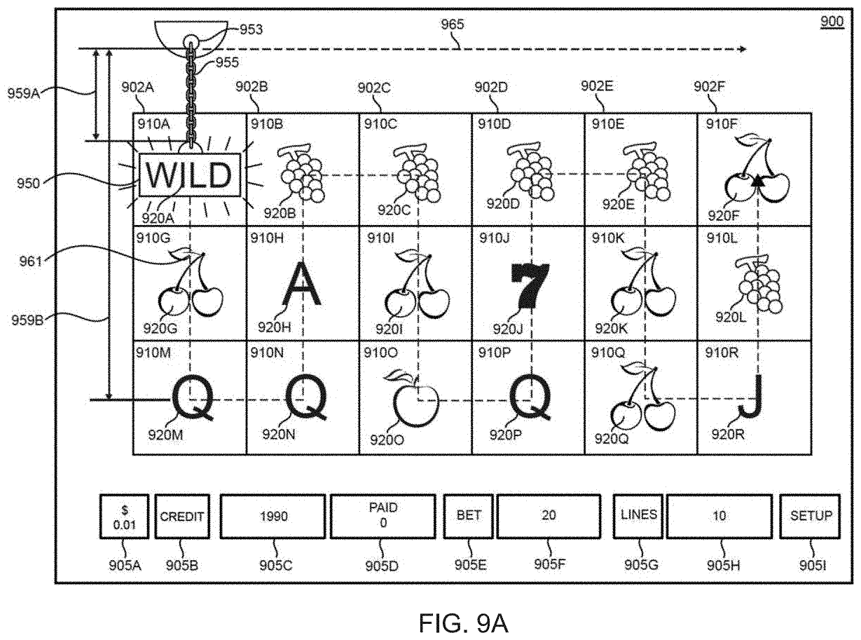

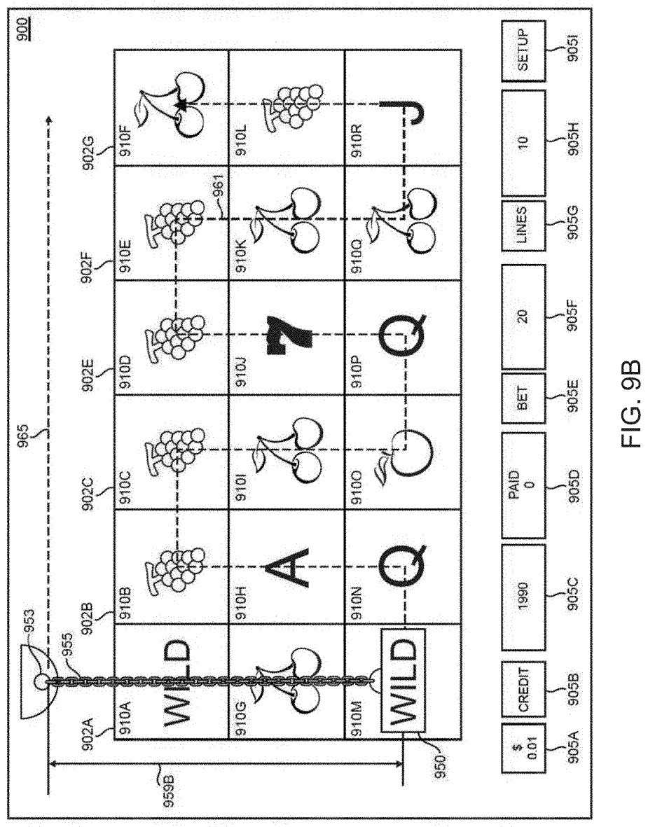

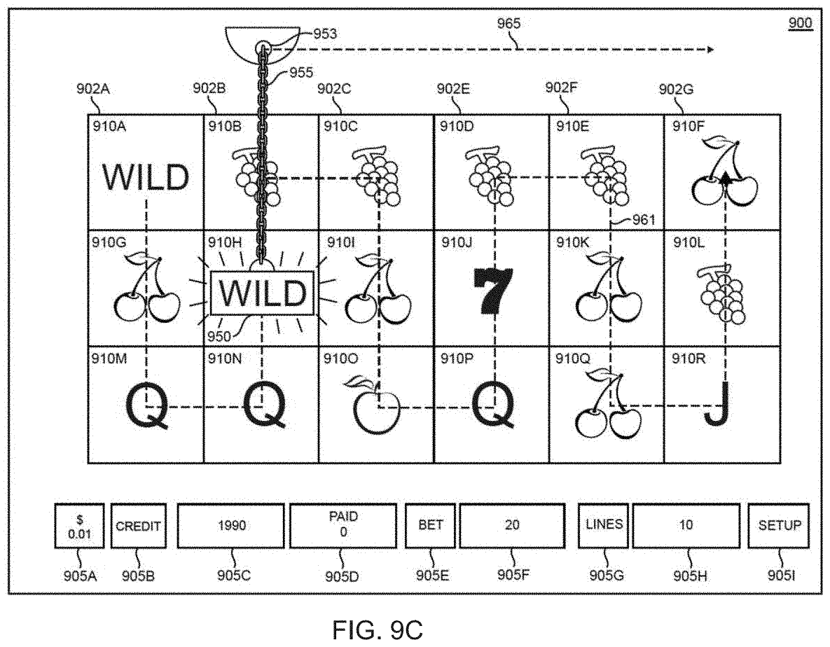

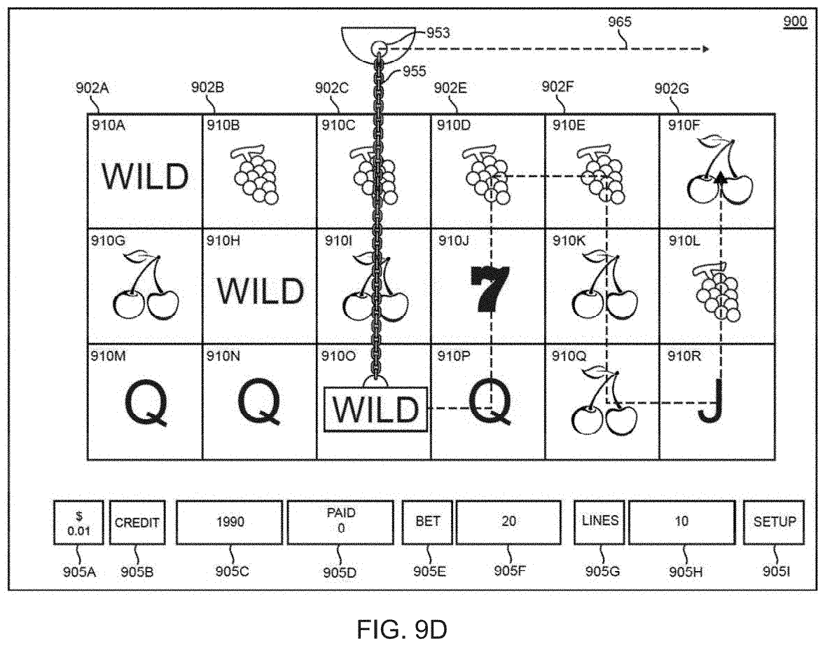

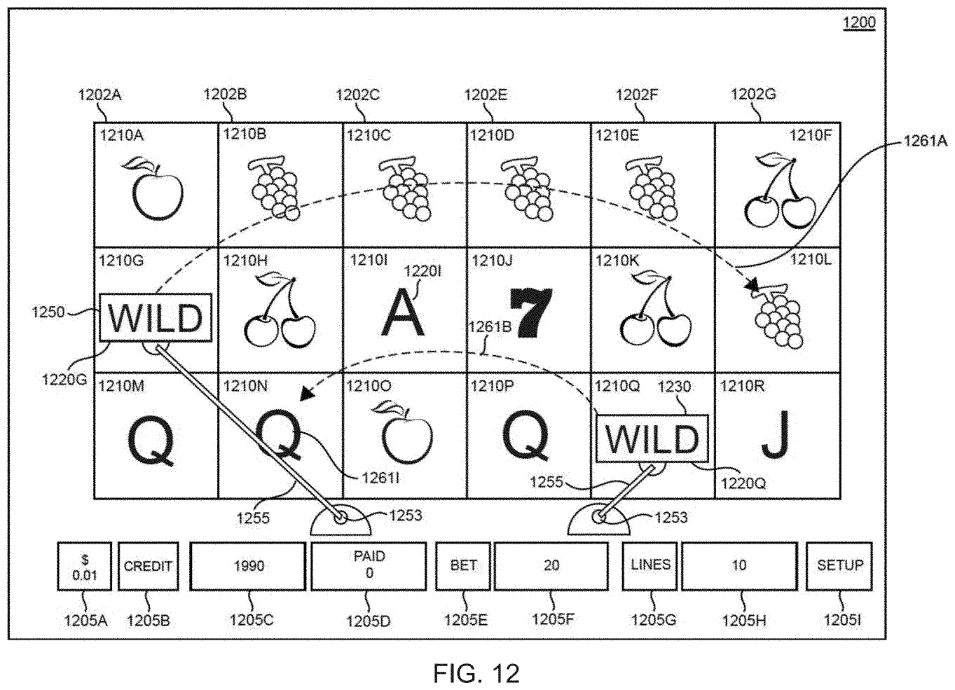

In accordance with some implementations of the present disclosure, at block 845, the gaming system can determine a distance between an anchor and the replicating symbol identified at block 843 in a same or similar manner to that previously described with regard to block 374 of FIG. 3D. The anchor can be the same or similar to the anchor previously described herein. In accordance with aspects of the present disclosure, the anchor can be at a position proximate to and apart from the symbol display areas. For example, in implementations in which the symbol display represent reels, the anchor may be positioned in the game screen outside the perimeter of the reels. In some implementations, the anchor can be fixed in the game screen during the play of the replicating game. For example, where the symbol display areas represent reels, the anchor can be horizontally-centered above the reels (e.g., as illustrated in 11A-11C) or below the reels (such as illustrated in FIG. 12). In some implementations, the anchor can be above or below the corners of the reels (e.g., as illustrated in FIGS. 9A-9D). In different plays of the game, the anchor may change. For example, the gaming system can select a position of the anchor from among a number of different locations around the reels for different plays of the game. In some implementations, the gaming system can randomly select the placement of the anchor. In some implementations, the anchor can move in the game screen. For example, the gaming system can initially position the anchor above the leftmost reel and horizontally move the anchor as the replicating symbol moves through the symbol display areas.

At block 847, the gaming system can display a connector connecting the anchor to the replicating symbol in a same or similar manner to that previously described with regard to block 376 of FIG. 3D. In accordance with aspects of the present disclosure, the connector can have a length corresponding to the distance determined at block 845. In some implementations, the connector can have a substantially fixed length. In other implementations, the connector can have an initial length that varies between a minimum length and a maximum length as the replicating symbol moves through the symbol display areas. For example, the initial length can be the distance between the anchor and the location of the replicating symbol. In some implementations, the minimum length and the maximum length are predetermined values. In some implementations, the minimum length can be less than or equal to a distance between the anchor and a location of a symbol display area closest to the anchor. The maximum length can be greater than or equal to the distance between the anchor and the location of the replicating symbol.

At block 849, the gaming system can determine whether the symbols determined at 839 for the symbol display areas include any blocking symbols. The blocking symbols can be one or more symbols included in the symbol sets used at block 839 that function to block the movement of the replicating symbol through their respective symbol display areas. For example, the blocking symbols can be a special symbol representing as a wall, a boulder, a tree, a person, a shield, or the like. In some implementations, movement of the replicating symbol may stop at a blocking symbol. For example, in an implementation in which the connector has a fixed length giving the replicating symbol a parabolic or arcuate path (e.g., a swinging chain, rope, or vine), the gaming system may stop the movement of the replicating symbol to stop in a first symbol display area prior to the blocking symbol and, instead, fall from the connector. The fall of the replicating symbol may be into a randomly selected symbol display area below the first symbol display area. In other implementations, the gaming system may modify the path of the replicating symbol such that the path avoids (e.g., reverses or diverts) symbol display area including a blocking symbol.

At block 851, the gaming system determines a path for the replicating symbol. In some implementations, the path can be determined in the same or similar manner to that previously described with regard to block 378 of FIG. 3D. For example, the replicating symbol can move through the symbol display areas in a pendulum-like motion. That is, the anchor can be a pivot connected to the replicating symbol by the connector such that the replicating symbol swings in a parabolic or arcuate path. In some such implementations, the replicating symbol can cyclically move in a forward direction and a reverse direction in a similar manner to a pendulum. In some implementations, the gaming system may change the length of the connector when the direction of movement changes such that the replicating system traces a second path through the symbol display areas during a reverse cycle than for path of the forward cycle. In other implementations, gaming system may determine one or more linear paths through the symbol display areas. For example, the replication symbol can move through the symbol display areas as if the connector was a spring extending and contracting as both the replicating symbol and anchor move across the game screen in coordination to provide paths having various shapes. Moreover, as noted above, in some implementations the gaming system may modify the path of the replicating symbol such that it avoids symbol display locations including blocking symbols determined at block 849.

At block 853, the gaming system determines one or more symbol display areas as stop positions for the replicating symbol in a same or similar manner to that previously described with regard to block 382 of FIG. 3D. In some implementations, the determination at block 853 may be a random selection from the symbol display areas. Turning to FIG. 8D, as indicated by off-page connector “E,” at block 855, the gaming system can determine a path for the anchor. In some implementations, the path of the anchor can be one of several predefined paths corresponding to the initial location of the anchor or of the replicating symbol. The gaming system can determine the path by determining the location of the replicating symbol or the anchor and retrieving the predefined path corresponding to the location. For example, where the symbol display areas are arranged as vertically-aligned reels and the initial location of the anchor is above a leftmost reel, the path of the anchor may be in a horizontal line from the leftmost reel to the rightmost reels. In some implementations, the gaming system moves the anchor along the path is at a substantially constant velocity. In implementations, the horizontal movement of the anchor can be coordinated with that of the replicating symbol. For example, the horizontal movement of the anchor and the vertical movement of the replicating symbol can alternate such that the replicating symbol moves up or down the entire height of the individual reels. As such, the length of the connector can cause the replicating symbol to move in a square, sinusoidal, triangular, or sawtooth path across the symbol display areas.

At block 857, the gaming system moves the replicating symbol along the first path determined at block 851 in a same or similar manner to that previously described with regard to block 382 of FIG. 3D. In some implementations, at block 859, the gaming system moves the anchor along the second path determined at block 855. As discussed above, the anchor may move in coordination with the movement of the replicating symbol. For example, the anchor can move along the second path determined while the replicating symbol can moth along the first path. And, in some implementations the anchor moves alternately with the movement of the replicating symbol. For example, the anchor can move along the second path and stop above one or more game reels. While the anchor is stopped, the replicating symbol can move up or down the reels along the first path.

At block 861, the gaming system displays one or more copies of the replicating symbol in the one or more stop positions for the replicating symbol determined at block 853, in a same or similar manner to that previously described at block 382 of FIG. 3D. At block 863, the gaming system determines an award for the replicating game based on combinations the symbols displayed at block 841 and the one or more copies of the replication symbol displayed at block 857 in a same or similar manner to that previously described at block 384 of FIG. 3D.

At block 865, the gaming system determines whether the symbols determined at block 839 for the symbol display areas or displayed in the symbol display areas at 841 include another replicating symbol in the symbol display areas in a same or similar manner to that previously described with regard to block 372 of FIG. 3C. If another replicating symbol remains (e.g., block 859 is “Yes”), the method 800 may advance to block 843, as indicated by off-page connector “F,” and proceed as previously described herein. On the other hand, if no replicating symbol remains (e.g., block 859 is “No”), the method 800 proceeds to block 859. At block 867, the gaming system updates the credit balance determined at block 825 in a same or similar manner to that previously described at block 388, the replicating game ends, and the method 800 returns to block 833 and proceeds as previously described herein.

FIGS. 9A-9D illustrate screen shots of a game screen 900 for a replicating game that may be provided in some implementations of a gaming system in accordance with the present disclosure (e.g., gaming system 100). The replicating game illustrated in FIGS. 9A-9D may be triggered in a same or similar manner to that previously described with regard to FIGS. 4A and 4B. That is, in some implementations, FIGS. 4A and 4B illustrate a base game that triggers the replicating game illustrated in FIGS. 9A-9D, wherein the base game and the replicating game are part of a play of a game in some implementations. In is understood that the other implementations of the gaming system can use a base game different from that illustrated in FIGS. 4A and 4B.

The game screen 900 displays a set of slot machine reels 902A, 902B, 902C, 902D, 902E, and 902F. Consistent with the examples previously discussed herein, the reels 902A-902F illustrated in FIGS. 9A-9D are positioned side by side in the game screen 900. It is understood, however, that the reels 902A-902F can be displayed with any suitable amount of separation or no separation. It is understood that the game shown in game screen 900 is merely representative and that some implementations consistent with the present disclosure may have more or fewer elements (e.g., reels, symbol display areas, symbols, etc.) than are shown in the game screen 900. Notably, the game screen 900 also includes several information areas and buttons 905A-905I, which can be the same or similar to those previously described herein (e.g., information areas and buttons 405a-405i).

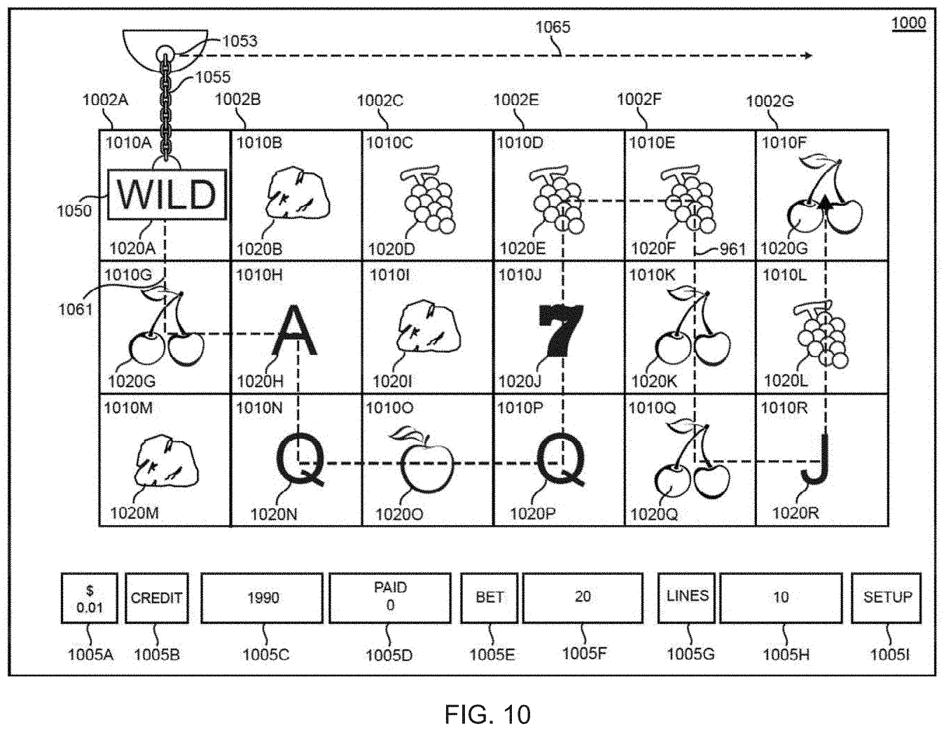

The reels 902A-902F can be associated with respective sets of symbols (e.g., symbols 214) for the replicating game, where each set of symbols includes a number of symbols, as previously described herein. For example, the sets of symbols can include one or more replicating symbols, which may be a “WILD” symbol in some implementations. Additionally, the sets of symbols can include special symbols, such as blocking symbols (e.g., as previously described herein with regard to block 849 of FIG. 8C and described below with regard to FIG. 10). The reels 902A-902F include symbol display areas 910A, 910B, 910C, 910D, 910E, 910F, 910G, 910H, 9101, 910J, 910K, 910L, 910M, 910N, 9100, 910P, 910Q, and 910R which can be the same or similar to those previously described herein (e.g., symbol display areas 410a-410r). The symbol display areas 910A-910R may display symbols 920A-920R determined by the gaming system using the respective sets of symbols of reels 902A-902F. As illustrated in FIGS. 9A-9D, individual symbol display areas 910A-910R display respective symbols 920A-920R. It is understood that some implementations, one or more of the symbols 920A-920R can span more than one of the symbol display areas 910A-910R. Additionally, while some implementations of the reels 902A-902F include horizontal lines delineating the symbol display areas 910A-910R within the individual reels 902A-902F, it is understood that other implementations may not include such delineations.

The gaming system can automatically or manually initiate a play of the replicating game (such as previously described with regard to block 837 of FIG. 8C) based on a trigger event (such as previously described with regard to block 831 of FIG. 8B). As also previously described, in some implementations, the trigger event can be the display of the predetermined symbol in one or more of the symbol display areas 910A-910R. In the present example, predetermined symbol can be symbol 920A (“WILD”) displayed in symbol display area 910A. In response to the display of the predetermined symbol, the gaming system can identify the symbol 920A as a replicating symbol 950 for the replicating game. In some implementations, the gaming system can modify the display of the symbol 920A to provide a visual indication of the symbol's designation. The visual indication may be, for example, converting the symbol 920A to another symbol, changing the background of the symbol, highlighting the symbol, or providing some other suitable thematic change or indication of the trigger symbol 920A functionality as the replicating symbol 950.

Additionally, in response to the display of the predetermined symbol initiating the replicating game, the gaming system can determine a distance between an anchor 953 and the replicating symbol 950 (such as previously described herein with regard to block 845 of FIG. 8C). Using the determined distance, the gaming system can generate and display a connector 955 connecting the anchor 953 to the replicating symbol 950 (such as previously described herein with regard to block 847 of FIG. 8C). In some implementations, the length of the connector 955 can be a distance between a minimum length 959A of the connector 955 and a maximum length 959B of the connector 955. In some implementations where the anchor 953 is above the reels 902A-902F, the minimum length 959A can correspond to a distance between the anchor 953 and one of the symbol display areas 910A-910R in the reels 902A-902F directly below and nearest to the anchor 953 (e.g., symbol display area 910A in the example illustrated). In such implementations, the maximum length 959B can correspond to a distance between the anchor and symbol display area in the reel (e.g., reel 902A) directly below and furthest from the anchor (e.g., symbol display area 910M in the example illustrated).

In some implementations, the gaming system also determines a path 961 for the replicating symbol 950 through the symbol display areas 910A-910R of the game screen 900 (such as previously described with regard to block 851 of FIG. 8C). In the implementation illustrated in FIG. 9A, the path 961 of the replicating symbol 950 can be cyclical upward and downward movement through the game reels 902A-902F, allowing the replicating symbol 950 to, in various implementations, move through some or all of the symbol display areas 910A-910R. In some implementations, the gaming system may cycle the length of the connector 955 such that it cycles between the minimum length 959A and the maximum length 959B such that path 961 traces through all the symbol display area 910A-910R. In some other implementations, the gaming system may vary the length of the connector 955 between the minimum length 959A and a portion of the maximum length 959B such that path 961 trace through some the symbol display area 910A-910R. For example, the gaming system can randomly select one of three possible lengths for the connector 955 between the minimum length 959A and the maximum length 959B such that path 961 may randomly pass through one, two or three of the symbol display areas 910A-910R of the individual reels 902A-902F. In a particular example, based on the random determination of the connector's 955 length, the gaming system may cause the path 961 of the replicating symbol to pass through symbol display areas 910A and 910G of reel 902A, symbol display areas 910B, 910H, and 910N of reel 902B, and only symbol display area 910C of reel 902C.

In some implementations, the gaming system also determines at least one stop position for the replicating symbol 950 (such as previously described with regard to block 853 of FIG. 8C). In some implementations, the gaming system determines the symbol display areas 910A-910R included in the path 961 of the replicating symbol 950 and randomly selects one or more the determined symbol display areas to be a stop position for the replicating symbol 950. For example, the gaming system can randomly select symbol display area 910H as a stop position. In some other implementations, particular symbols can be used as stop position for the replicating symbol 950. The particular symbols can be predetermined or randomly selected from those included in the sets of symbols. For example, the gaming system can select the ACE symbol 920H (e.g., “A”) as a stop symbol for a particular play of the replicating game.

Additionally, in some implementations, the gaming system can determine a path 965 for the anchor 953 (such as previously described with regard to block 855 of FIG. 8D). In the present example, the path 965 of the anchor 953 is a horizontal path across the tops of the reels 902A-902F. As illustrated in FIGS. 9A-9D, the gaming system can move the replicating symbol 950 and the anchor 953 along their respective paths 961 and 965. For example, the anchor 953 may move horizontally over the reels 902A-902F while the replicating symbol 950 moves through the symbol display areas 910A-910R. In some implementations, the gaming system moves the anchor 953 along the path at a substantially constant velocity. In some such implementations, the horizontal movement of the anchor 953 can be performed while the replicating symbol 950 moves vertically between the maximum length 959B of the connector 955 and the minimum length 959A of the connector 955. As such, the replicating symbol can move in a periodic path (e.g., sinusoidal, or triangular) across the symbol display areas 910A-910R. In some implementations, the gaming system pauses the movement of the predetermined above each of the reels 902A-902F. In some such implementations, the horizontal movement of the anchor 953 and the vertical movement of the replicating symbol can alternate such that the replicating symbol moves up or down each reel in an oscillating path (e.g., square or sawtooth). In this implementation, because the anchor 953 and the replicating symbol 950 were generated at or near reel 902A, the gaming system may move the replicating symbol 950 from left to right along the path 961. On the other hand, if the anchor 953 and the replicating symbol 950 had been generated at or near reel 902F, the gaming system may move replicating symbol 950 from right to left. While the present examples illustrates the replicating symbol moving 950 vertically and the anchor moving horizontally, it is understood that some implementations may include the replicating system 950 moving horizontally or the anchor 953 moving vertically.

The gaming system may move the replicating system 950 along the path 961 in connection to the anchor 953. During the movements, the gaming system can place or drop copies (e.g., replicants) of the replicating symbol 950 at the stop positions. The copies can replace the symbols previously displayed at the stop positions so as to create new winning combinations of symbols that may additional awards. Notably, a copy of the “Wild” symbol 920A in symbol display area 910A may remain in its original position while the replicating symbol 950 originating from the “Wild” symbol 920A moves.

In the implementation illustrated in FIGS. 9A-9D, the gaming system can display the copies of the replicating symbol 950 in one or more of the symbols display area 910A-910R along the path 961 of the replicating symbol 950. As noted above, in some implementations, the replicating symbol 950 is not replicated until it crosses a symbol display area determined to be a stop position. For example, as illustrated in FIG. 9C, the symbol display area 910H can be a stop position for the replicating symbol. More specifically, FIG. 9C depicts the gaming system moving the replicating symbol 950 along the path 961, which leads over the symbol display area 910H having an ACE symbol 920H. In some implementations, the replicating symbol 950 can be layered over the symbol 920H in the stop position without replacing the ACE symbol. In other implementations, such as illustrated in FIG. 9D, the gaming system replaces any symbols in a symbol display area that is also occupied by the replicating symbol 950 with a copy (e.g., “WILD”). That is, in some implementations, when the gaming system replaces the ACE symbol 920H with the WILD symbol in symbol display area 910H.

In a same or similar manner to that previously described herein (e.g., with regard to blocks 821 and 823 of FIG. 8D), the gaming system determines one or more awards for the replicating game based on the symbols 920A-920R in symbol display areas 910A-910R, including the replicant symbols, such as the WILD symbol 920H in symbol display area 910H. For example, the gaming system can evaluate the displayed symbols 920A-920R based on a pay table associated with the gaming system (such as the pay table in FIG. 5). In some implementations, the gaming system may perform an initial evaluation of the displayed symbols 920A-920R for winning symbol combinations before providing any copies of the replicating symbol 950. In some such implementations, the gaming system may provide the player with awards associated with both evaluations (awards without the replicant symbols and awards with the replicant symbol). As such, the gaming system can increase the amount of symbols available for evaluating winning symbol combinations in some implementations. Further, as previously described herein, in some implementations, the gaming system only evaluates pay lines that include copies of the replicating symbol. By skipping evaluation of all of the generated and displayed symbols, the efficiency of the gaming system can be improved because less memory and less processing power is used. This efficiency also translates into faster game play because less time is used to complete the game's evaluation. When such efficiency improvements are made and applied to the hundreds and thousands of games evaluation that are made on a casino floor during a given period of time for the disclosed gaming system, the new gaming system will provide casino game operators substantial gains in machine efficiency.

FIG. 10 illustrates a screen shot of an implementation of a replicating game provided by some implementations of a gaming system (e.g., gaming system 100) in accordance with aspects of the present disclosure. The implementation illustrated in FIG. 10 may function in a same or similar manner to that described above with regard to FIGS. 9A-9D. The game screen 1000 includes game reels 1002A-1002F, including symbol display areas 1010A-1010R, replicating symbol 1050, anchor 1053, and connector 1055, which all can be the same or similar to those described above with regard to FIGS. 9A-9D. Additionally, the replicating symbol 1050 and the anchor 1053 can move along paths 1061 and 1065, respectively, in a similar manner to that previously described above (e.g., paths 961 and 965). Further, the gaming system can determine symbols 1020A-1020R for the symbol display areas 1010A-1010R from respective sets of symbols. In accordance with some implementations of the present disclosure, sets of symbols for the replicating game can include blocking symbols that limit the path 1061 of the replicating symbol 1050. As illustrated in FIG. 10, the symbol display areas 1010B, 1010L, and 1010M display blocking symbols 1020B, 1020L, and 1020M. The path 1061 of the replicating symbol 1050 through the symbol display areas 1010A-1010R is restricted by the blocking symbols 1020B, 1020L, and 1020M such that the movement of the connector 1055 or the replicating symbol 1050 traces the path 1061 avoiding the locations of the blocking symbols 1020B, 1020L, and 1020M. For example, the gaming system may determine the path 1061 for moving the replicating symbol 1050 through the symbol display areas 1010A-1010R (e.g., path 961 in FIGS. 9A-9D) and modify such path to avoid the blocking symbols 1020B, 1020L, and 1020M. Absent the blocking symbols 1020B, 1020L, and 1020M in reels 1002A, 1002B, and 1002C, the replicating symbol 1050 may follow a determined cyclical path (e.g., path 961), as illustrated in reels 1002D, 1002E, and 1002F.

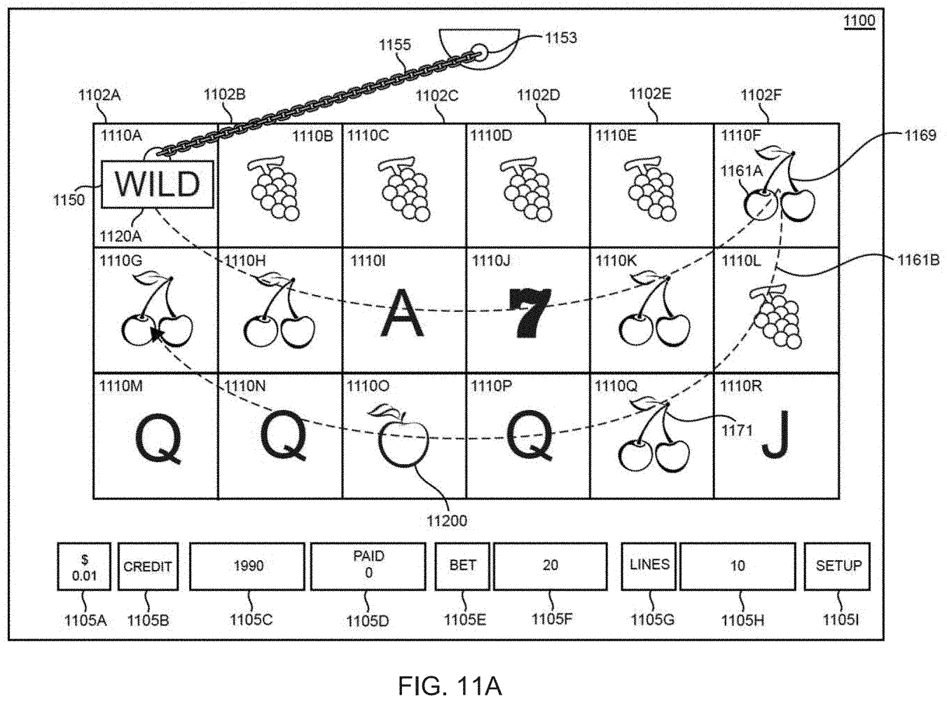

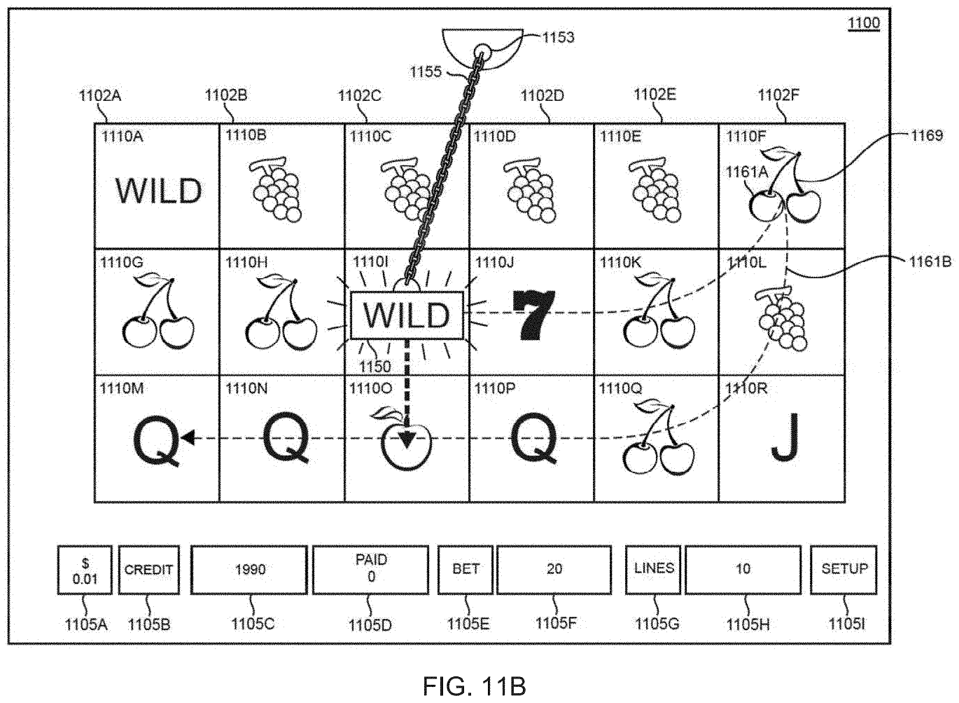

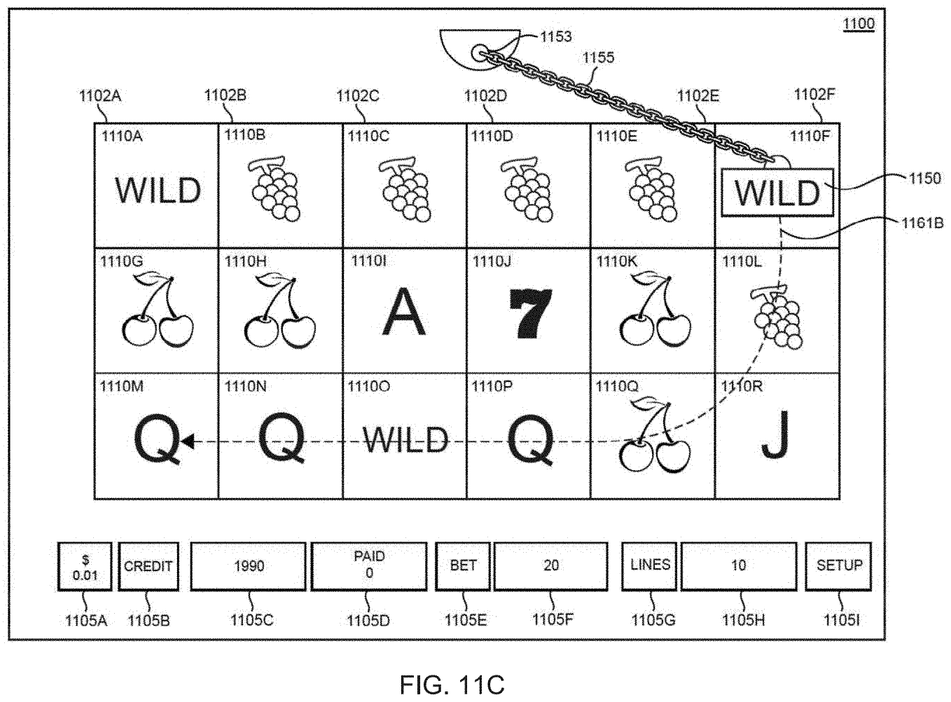

FIGS. 11A-11C illustrate screen shots of a replicating game provided by some implementations of a gaming system (e.g., gaming system 100) in accordance with aspects of the present disclosure. The implementation illustrated in FIGS. 11A-11C may function in a similar manner to that described above with regard to FIGS. 4A-4F. As illustrated in FIG. 11A, a game screen 1100 includes game reels 1102A-1102F, including symbol display areas 1110A-1110R, replicating symbol 1150, anchor 1153, and connector 1155 which all can be the same or similar to those described above. In the present example, the anchor 1153 is positioned at a top of the game screen 1100 and centered above the reels 1102A-1102F. It is understood that the anchor 1053 can be positioned at other locations around the reels 1102A-1102F. For example, the anchor 1153 can be positioned below the reels 1102A-1102F, such as illustrated in FIG. 12.

Also, in a similar manner to that previously described with regard to FIGS. 4A-4F and FIGS. 9A-9D, the gaming system can determine a length of the connector 1155 based on a distance of the replicating symbol 1150 in symbol display area 1110A from the anchor 1153. As described previously, the length of the connector can have a predetermined minimum length and a predetermined maximum length. In some implementations, the predetermined minimum length can be the distance from the anchor 1153 to symbol display area 1110C. The predetermined maximum length can be the distance from the anchor 1153 to symbol display area 1110M.

Further, in a same or similar manner to that previously described herein with regard to FIGS. 4A-4F, the gaming system can determine one or more paths 1161 of the replicating symbol 1150. The gaming system can determine the one or more paths 1161 based on the length of the connector 1155 and the position of the anchor 1153. As described previously, a first end of the connector 1155 can be attached to the anchor 1153, which is at a fixed location of the game screen, while a second end of the connector can be attached to the replicating symbol 1150, which moves through the symbol display areas 1110A-1110R in the one or more paths 1161 based on the length of the connector 1155. As the position of anchor 1153 is fixed, the anchor 1153 can function as a pivot on which the replicating symbol 1150 and the connector can move in a pendulum-like motion. Accordingly, the one or more paths 1161 can have a parabolic or arcuate shape.

In accordance with some implementations, the gaming system can vary the length of the connector 1155 between the predetermined minimum length and the predetermined maximum length. In some such implementations, the gaming system can change the length of the connector at or near the location 1169 where the path 1161A reverses direction of movement of the replicating symbol 1150. For example, the gaming system can change the length of the connector after the replicating symbol 1150 completes a swing from left-to-right. Additionally, or alternatively, the gaming system can change the length of the connector 1155 during the swing of the replicating symbol along the one or more paths 1161. For example, at location 1171 in symbol display area 1110Q, the gaming system may change the length of the connector 1155 such that path 1161B of the replicating symbol 1150 remains over the symbol display areas 1110P and 11100, instead of traveling outside of the reels 1110A-1110F. By doing so, the path 1161 move the replicating symbol 1150 through the symbol display areas 1110A-1110R.

As the replicating symbol 1150 moves along the path 1161, copies of the replicating symbol may randomly replace symbols in the symbol display areas 1110A-1110R in a similar manner to that described previously herein. For example, as the replicating symbol 1150 moves, it may intersect with stop symbols, which may cause replacement of one of the symbols displayed in the symbol display areas 1110A-1110R. In some implementations, such as illustrated in FIGS. 11A-11C, a stop symbol can cause a replicant of the replicating symbol 1150 to replace one of the several symbols displayed in one of the reels 1102A-1102F. For example, if the replicating symbol 1150 crosses a symbol display areas 1110I including a stop symbol 11201 (“A”) in the path 1161, then the gaming system can randomly select one of symbol display areas 1110C, 1110I, and 1110O of reel 1102C for replacement by a copy of the replicating symbol 1150. More specifically, as illustrated in FIGS. 11B and 11C, in response to selecting symbol display area 1110O in reel 1102C, the gaming system may display a copy of the replicating symbol 1150 falling from symbol display area 1110I to the selected symbol display area 1110O, and replacing the original symbol 1120O (e.g., an Orange symbol) with the replicant symbol (e.g., a WILD symbol). The gaming system can evaluate symbols displayed in the reels 1102A-1102F, including the replicant symbol, for winning symbol combinations, as previously described herein. While FIGS. 11B and 11C depict replicating symbol 1150 falling from symbol display area 1110I to the selected symbol display area 1110O, it is understood that, instead, the gaming system may select symbol display area 1110C and display replicating symbol 1150 jumping from symbol display area 1110I to the selected symbol display area 1110C.

FIG. 12 illustrates a screen shot of an implementation of a replicating game provided by some implementations of a gaming system (e.g., gaming system 100) in accordance with aspects of the present disclosure. The implementation illustrated in FIG. 12 may function in a similar manner to that described above with regard to FIGS. 4A-4F and 11A-11C. As illustrated in FIG. 12, a game screen 1200 includes game reels 1202A-1202F, including symbol display areas 1210A-1210R, which can be the same or similar to those described above. Additionally, the game screen 1200 can include one or more replicating symbols 1250, anchors 1253, connectors 1255, and paths 1261. In the present example, the anchors 1253 are positioned below the reels 1202A-1202F. It is understood, however, that the anchors 1253 can be positioned elsewhere outside the perimeter of the reels 1202A-1202F, as previously described herein. Further, in implementations consistent with the present example, the gaming system can provide a quantity of the anchors 1253 and the connectors 1255 corresponding a quantity of replicating symbols generated for the replicating game. For example, as illustrated in FIG. 12, if the reels 1202A-1202F display a single trigger symbol 1220G, then the gaming system may designate that trigger symbol 1220G as a replicating symbol and generate a single anchor 1253, connector 1255, and path 1161, in a same or similar manner to that previously described with regard to FIGS. 4A-4F. On the other hand, as illustrated in FIG. 12, if the reels 1202A-1202F display a two trigger symbols 1220G and 1220Q, then the gaming system may designate the two trigger symbols 1220G and 1220Q as replicating symbols 1250 and generate a two anchors 1253, connectors 1255, and paths 1261, in a similar manner to that previously described with regard to FIGS. 4A-4F. The paths 1261 can have the same or different directions. Further, the paths 1261 can be intersecting or non-intersecting. The replicating symbols 1250 moving in the paths 1261 can place copies in the symbol display areas 1210A-1210R in a same or similar manner to that previously described herein. For example, in the event the gaming system determines that the “A” symbol 1220I in symbol display area 1210I is a stop symbol, the one of the replicating symbols 1250 may replace symbol 1220I with a copy of the replicating symbol 1250 when its movement along the respective path 1261 crosses the symbol display area 12101. While FIG. 12 shows two instances of the replicating symbols 1250, anchors 1253, connectors 1255, and paths 1261, it is understood that some implementations can include three or more of such instances. For example, a particular play of the replicating game may include one instance of the replicating symbols 1250, anchors 1253, connectors 1255, and paths 1261 for each row of symbol display area 1210A-1210R.

Based on the forgoing description, it should be appreciated that a gaming system and method with improvements to game outcomes based on replicating symbols creates new and very exciting ways for a player to obtain improved winnings with a potential to earn frequent and greater awards or to turn a losing gaming into a winning game. Such a potential to earn greater awards creates a greatly improved sense of anticipation for players.

A number of implementations of the invention have been described. Various modifications may be made without departing from the spirit and scope of the invention. For example, various forms of the flows shown above may be used, with steps re-ordered, added, or removed. Accordingly, other implementations are within the scope of the following claims.

We claim:

1. A gaming system comprising:
a display device, an input device, a value acceptor, a value dispenser, a random number generator, a memory device, and a processor, wherein the memory device stores program instructions that, when executed by the processor, cause the gaming system to:
receive, via the input device, a wager for a play of a game using a credit balance established for the gaming system;
randomly determine, using the random number generator, symbols for symbol display areas;
display, using the display device, the symbols in the symbol display areas;
determine that a replicating symbol is displayed in response to an occurrence of a predetermined event;
move the replicating symbol through the symbol display areas;
randomly determine one or more of the symbol display areas as stop positions for the replicating symbol;
display, using the display device, one or more copies of the replicating symbol based on the stop positions for the replicating symbol;
determine an award based on the symbols and the one or more copies of the replicating symbol;
update the credit balance based on the award; and
issue, using the value dispenser, a value based on the credit balance in response to a cash out request.

2. The gaming system of claim 1, wherein:
a connector connects the replicating symbol to an anchor;
the program instructions further cause the gaming system to determine a first path for the replicating symbol based on a position of the anchor and a length of the connector; and
moving the replicating symbol comprises moving the replicating symbol along the first path while maintaining the connection of the replicating symbol to the anchor by the connector.

3. The gaming system of claim 2, wherein a length of the connector varies as the replicating symbol moves along the first path.

4. The gaming system of claim 2, wherein program instructions further cause the gaming system to:
move the anchor along a second path in combination with moving the replicating symbol along the first path while maintaining the connection between the replicating symbol to the anchor by the connector.

5. The gaming system of claim 4, wherein:
the symbol display areas are arranged in a plurality of vertical columns representing a plurality of game reels; and
moving the anchor along the second path comprises moving the anchor across the plurality of game reels.

6. The gaming system of claim 5, wherein displaying the one or more copies comprises:
displaying a first copy of the one or more copies in a first symbol display area of a first game reel of the plurality of game reels that contains a first of the stop positions for the replicating symbol.

7. The gaming system of claim 1, wherein the program instructions further control the gaming system to:
determine that one or more of the symbol display areas display a blocking symbol; and
determine a first path to move the replicating symbol through a plurality of the symbol display areas, wherein the first path excludes the one or more of the symbol display areas displaying the blocking symbol.

8. The gaming system of claim 1, wherein displaying the one or more copies comprises:
displaying the one or more copies of the replicating symbol in the stop positions for the replicating symbol.

9. The gaming system of claim 1, wherein:
displaying the one or more copies of the replicating symbol in the one or more of the symbol display areas comprises replacing the symbols displayed in the one or more symbol display areas.

10. A method comprising:
receiving, by a processor, a wager for a play of a game using a credit balance established for a gaming system;
randomly determining, by the processor, symbols for symbol display areas;
displaying, by the processor using a display device, the symbols in the symbol display areas;
determining that a replicating symbol is displayed in response to an occurrence of a predetermined event;
moving, by the processor, the replicating symbol through the symbol display areas;
randomly determining, by the processor, one or more of the symbol display areas as stop positions for the replicating symbol;
displaying, by the processor, one or more copies of the replicating symbol based on the stop positions for the replicating symbol;
determining, by the processor, an award based on the symbols and the one or more copies of the replicating symbol;
updating, by the processor, the credit balance based on the award; and
issuing, by the processor, a value based on the credit balance in response to a cash out request.

11. The method of claim 10, wherein the method further comprises:
providing a connector connecting the replicating symbol to an anchor;
determining a first path for the replicating symbol based on a position of the anchor and a length of the connector; and
moving the replicating symbol comprises moving the replicating symbol along the first path while maintaining the connection of the replicating symbol to the anchor by the connector.

12. The method of claim 11, wherein a length of the connector varies as the replicating symbol moves along the first path.

13. The method of claim 11, method further comprising:
moving the anchor along a second path in combination with moving the replicating symbol along the first path while maintaining the connection between the replicating symbol to the anchor by the connector.

14. The method of claim 13, wherein:
the symbol display areas are arranged in a plurality of vertical columns representing a plurality of game reels; and
moving the anchor along the second path comprises moving the anchor across the plurality of game reels.

15. The method of claim 14, wherein displaying the one or more copies comprises:
displaying a first copy of the one or more copies in a first symbol display area of a first game reel of the plurality of game reels that contains a first of the stop positions for the replicating symbols.

16. The method of claim 10, wherein the method further comprises:
determining that one or more of the symbol display areas display a blocking symbol; and
determining a first path to move the replicating symbol through a plurality of the symbol display areas, wherein the first path excludes the one or more of the symbol display areas displaying the blocking symbol.

17. The method of claim 10, wherein displaying the one or more copies comprises:
displaying the one or more copies of the replicating symbol in the stop positions for the replicating symbol.

18. The method of claim 10, wherein:
displaying the one or more copies of the replicating symbol in the one or more of the symbol display areas comprises replacing the symbols displayed in the one or more symbol display areas.

19. A non-transitory computer-readable storage device having program instructions stored thereon, the program instructions being executable by a processor to cause a gaming system to:
receive a wager for a play of a game using a credit balance established for the gaming system;
initiate a play of the game;
randomly determine symbols for symbol display areas;
display, using a display device, the symbols in the symbol display areas;
determine that a replicating symbol is displayed in response to an occurrence of a predetermined event;
move the replicating symbol through the symbol display areas;
randomly determine one or more of the symbol display areas as stop positions for the replicating symbol;
display one or more copies of the replicating symbol based on the stop positions for the replicating symbol;
determine an award based on the symbols and the one or more copies of the replicating symbol;
update the credit balance based on the award; and
issue a value based on the credit balance in response to a cash out request.

20. The non-transitory computer-readable storage device of claim 19, wherein:
a connector connects the replicating symbol to an anchor;
the program instructions further cause the gaming system to determine a first path for the replicating symbol based on a position of the anchor and a length of the connector; and
moving the replicating symbol comprises moving the replicating symbol along the first path while maintaining the connection of the replicating symbol to the anchor by the connector, and
the length of the connector varies as the replicating symbol moves along the first path.
